(19) United States
(12) Patent Application Publication
(10) Pub. No.: US 2015/0284145 A1
(43) Pub. Date: Oct. 8, 2015

(54) Pouch container

(71) Applicant: NIHON YAMAMURA GLASS CO., LTD., Amagasaki-shi, Hyogo (JP)

(72) Inventors: Katsuya Arimoto, Amagasaki-shi (JP); Kenji Tanaka, Amagasaki-shi (JP); Shinichiro Ogura, Amagasaki-shi (JP); Takashi Hagio, Amagasaki-shi (JP); Keiji Baba, Matsuyama-shi (JP); Naoki Shima, Tokyo (JP)

(73) Assignee: NIHON YAMAMURA GLASS CO., LTD., Amagasaki-shi, Hyogo (JP)

(21) Appl. No.: 14/433,192

(22) PCT Filed: Oct. 3, 2013
(86) PCT No.: PCT/JP2013/077000

§ 371 Date: Apr. 2, 2015

(30) Foreign Application Priority Data
Oct. 3, 2012 (JP) 2012-221054
Mar. 27, 2013 (JP) 2013-067223
Jun. 10, 2013 (JP) 2013-122064

(51) Int. Cl. B65D 33/25; B31B 29/00; B65D 30/08

(52) U.S. Cl. CPC B65D 33/25; B65D 31/02; B31B 29/00

(57) ABSTRACT

The invention provides a pouch container which is excellent in a design property as well as being excellent in a self-standing stability and a shape retention property, can be volume-reduced, can prevent an adhesive agent from seeping into the content even in the case of using a multilayer film material employing the adhesive agent, and can sufficiently secure a sealing performance between the body side end part joint portion and a closing member. In a self-standing pouch container (1) provided with a body member (4) which is made of a film material, and a lower end closing member (5) which closes one end opening portion of the body member (4) in a liquid tight manner and is made of a film material, an annular body side end part joint portion (4a) is formed in one end portion of the body member (4) by being bent inside, and an inside member (6) and an outside member (7) are provided as the lower end closing member (5), the inside member (6) being fusion bonded to an inner surface side of the container in the body side end part joint portion (4a) and the outside member (7) being fusion bonded to an outer surface side of the container.

### TECHNICAL FIELD

The present invention relates to a pouch container which is comprised of a soft film.

### BACKGROUND ART

As a refilling container which accommodates liquid material such as shampoo, rinse, and hand soap, and a container which stores gel food and drink such as jelly, a bag-like foldable pouch container has been widely put to practical use in general (for example, refer to Patent Document 1).

The pouch container which is self-standing in a state of being filled with content is put to practical use, however, since the container main body is comprised of the soft film, the container main body basically deforms into a flat shape according to reduction of the contents, so that there has been a problem that a self-standing stability is lowered and an outer appearance is lowered. Particularly, in the case that the pouch container is provided with a body member which is comprised of a film material formed into a tubular shape, and a bottom plate which closes a lower end opening portion of the body member and is comprised of a film material, and has a joint portion extending to a lower side from an outer peripheral portion of the bottom plate fusion bonded to a lower end inner surface of the body member, such as the pouch container described in Patent Document 1, the bottom plate comes to a floating state from an installation surface in a state in which the pouch container is installed. As a result, a center portion of the bottom plate deforms downward in a protruding manner due to its own weight of the content, and the body member is going to deform inward as a whole, so that there is a problem that the self-standing stability is lowered and the outer appearance is lowered.

Further, as a structure of the bottom portion of the pouch container, there has been proposed a bottom portion structured such that an annular body side end part joint portion is formed by folding a lower end portion of the body member inside, a bottom plate is inserted to an inner side of the body member, and a lower end opening portion of the body member is closed by fusion bonding an outer peripheral portion of the bottom plate to the body side end part joint portion (refer, for example, to Patent Document 2). In the pouch container described in the Patent Document 2, since approximately all the surface of the bottom surface is installed to an installation surface, the self-standing stability of the pouch container becomes higher, and there is further an advantage that the outer appearance of the container can be improved by reducing the deformation of the container due to its own weight of the content.

Further, in the pouch container described in the Patent Document 2, in order to prevent a problem generated by employing a multilayer film while constructing the body member and the bottom plate by the multilayer film, for example, obtained by laminating according to a dry lamination method, for enhancing a strength of the container and enhancing a gas barrier performance, that is, a problem that an outer peripheral end of the bottom plate is exposed to the container and an adhesive agent used at the forming time of the multilayer film seeps into the content filled in the container, so that the content is deteriorated, the content penetrates into an adhesive agent layer, and the film breaks away between the layers, the pouch container is structured as follows. More specifically, the bottom plate employs a bottom plate in which synthetic resin layers in the top layer and the bottom layer are fusion bonded so as to cover an outer peripheral edge of the bottom plate, the synthetic resin layer in the top layer of the bottom plate is structured such as to be a size larger than the synthetic resin layer in the other layer, and the lower surface of the top layer protruding outward from an outer edge of the other layer is fusion bonded to the body side end part joint portion over a whole periphery, thereby preventing the adhesive agent layer from being exposed to the container.

On the other hand, as an inner bag used by being accommodated in an outer container such as a container or a drum can, there has been proposed an inner bag which is provided with a body member made of a film material formed into a tubular shape, and a bottom plate closing a lower end opening portion of the body member, and is structured such that an annular body side end part joint portion is formed by folding inside a lower end portion of the body member, and the lower end opening portion of the body member is closed by pinching the body side end part joint portion between outer peripheral portions of two bottom plates so as to fusion bond the body side end part joint portion (refer, for example, to Patent Document 3).

### CITATION LIST

### Patent Literatures

Patent Document 1: International Publication WO 2008/096392
Patent Document 2: JP-A No. 2002-19792
Patent Document 3: Japanese Patent No. 5178140

### SUMMARY OF INVENTION

### Technical Problem

In the pouch container described in the Patent Document 2, the inner peripheral edge of the body side end part joint portion and the outer peripheral edge of the bottom plate are not exposed to the container even in the case of using the multilayer film according to the dry lamination method obtained by laminating an aluminum thin film for enhancing the functionality such as the gas barrier performance and the light blocking effect. As a result, it is possible to prevent the problem that the adhesive agent constructing the multilayer film seeps into the content, the content is deteriorated, the content penetrates into the adhesive agent layer, and the film breaks away between the layers. However, since the structure of the bottom plate is complicated, a manufacturing cost of the bottom plate is raised, and the body side end part joint portion obtained by folding the lower end portion of the body member inside becomes wrinkly, a sealing performance between the body side end part joint portion and the bottom plate is lowered, a sense of beauty of the bottom surface is deteriorated, and the self-standing performance is deteriorated.

Further, the inner bag described in the Patent Document 3 is used by being accommodated in the outer container such as the container or the drum can, and the inner bag itself is not provided with the self-standing performance. Further, since the film material manufactured by an inflation molding is used, the aluminum multilayer film can not be used, and there is a problem that a barrier performance is not high. Further, the inner bag described in the Patent Document 3 has a problem that the sealing performance between the body side end part joint portion and the bottom plate is lowered in the same manner as the invention described in the Patent Document 2, since the body side end part joint portion obtained by folding the lower end portion of the body member inside becomes wrinkly.

An object of the present invention is to provide a pouch container which is excellent in a design property as well as being excellent in a self-standing stability and a shape retention property, can be volume-reduced, can prevent an adhesive agent from seeping into the content even in the case of using a multilayer film material employing the adhesive agent, and can sufficiently secure a sealing performance between the body side end part joint portion and a closing member.

### Solution to Problem

A first pouch container according to the present invention is a self-standing pouch container provided with a body member which is made of a film material, and a closing member which closes one end opening portion of the body member in a liquid tight manner and is made of a film material, wherein an annular body side end part joint portion is formed in one end portion of the body member by being folded inside, and an outside member fusion bonded to an outer surface side of the container in the body side end part joint portion is provided as the closing member. In the present specification, the film material does not have severe meaning about a thickness, and is used as a generic name including a sheet material.

In the pouch container, since the body member and the closing member of the pouch container are comprised of the film material, the volume of the pouch container can be reduced by crushing the body member and the closing member flat after the use of the content. Further, since the annular body side end part joint portion is formed by folding the one end opening portion of the body member inside and the outside member is fusion bonded to the outer surface side of the container in the body side end part joint portion, the wrinkle can be covered with the outside member even in the case that the wrinkle is generated at the folding time of the body side end part joint portion. As a result, it is possible to prevent the design property from being lowered by exposure of the wrinkle to the outer portion. Further, in the case that the bottom surface of the pouch container is comprised of the outside member, the bottom surface of the pouch container is comprised of the flat outside member. Therefore, the pouch container can be self-standing by installing approximately a whole of the lower surface of the outside member in the installation surface with no gap, and it is possible to improve the self-standing stability and the shape retention property of the pouch container. Further, since the body side end part joint portion and the outer peripheral portion of the outside member fusion bonded thereto do not protrude outward from the body member, it is possible to improve the design property of the pouch container.

According to a preferable embodiment, the body member is comprised of a multilayer film formed by a lamination method or a coextrusion method with an adhesive agent. According to the structure, it is possible to apply functions such as a gas barrier performance, a light blocking effect, and an abrasion resistance to the body member, so that it is possible to enlarge a selection freedom of the content which can be accommodated in the pouch container, and it is possible to improve a durability of the pouch container. In the present specification, “lamination method with adhesive agent” means a lamination method including a dry lamination, a wet lamination, a hot lamination, a single lamination, a tandem lamination, and a coextrusion lamination. Further, in the present specification, “coextrusion method” means a manufacturing method of the multilayer film without using any adhesive agent, such as a thermal lamination method, a T die method, and an inflation method. The adhesive agent includes an AC agent (an anchor coat agent) which is used in an extrusion lamination in addition to an adhesive agent which is used in an adhesive agent lamination.

Further, according to a preferable embodiment, the outside member is comprised of a multilayer film manufactured by a lamination method or a coextrusion method with an adhesive agent. According to the structure, it is possible to apply functions such as the gas barrier performance and the abrasion resistance to the outside member, so that it is possible to enlarge the selection freedom of the content which can be accommodated in the pouch container and it is possible to improve the durability of the pouch container.

According to a preferable embodiment, the closing member is provided with the outside member, and an inside member which is fusion bonded to an inner surface side of the container of the body side end part joint portion, the inside member is comprised of a single layer film or a multilayer film according to the coextrusion method, and the inside member comparts an inner peripheral edge of the body side end part joint portion so as not to be exposed to the container.

In the pouch container, since the closing member is comprised of the inside member and the outside member, the rigidity of the bottom surface of the pouch container is enhanced in the case that the bottom surface of the pouch container is comprised of the closing member, and it is possible to improve the self-standing stability and the shape retention property of the pouch container. Further, in the case that the upper surface of the pouch container is comprised of the closing member, it is possible to improve the shape retention property of the pouch container. Further, since the inside member employs the inside member comprised of the single layer film or the multilayer film according to the coextrusion method, it is possible to securely prevent the adhesive agent from seeping into the content filled in the container from the outer peripheral edge of the inside member like the case of using the multilayer film manufactured by the dry lamination method, in spite of the fact that the outer peripheral edge of the inside member is exposed to the container. Further, since the inner peripheral edge of the body side end part joint portion is comparted by the inside member so as not to be exposed to the container, it is possible to securely prevent the adhesive agent from seeping into the content filled in the container from the inner peripheral edge of the body side end part joint portion even in the case of using the multilayer film manufactured by the dry lamination method for the body member.

In the case that the closing member is comprised of the outside member and the inside member like the pouch container, the following structures (1) to (5) can be employed according to preferable embodiments.

(1) It is preferable to fusion bond the inside member annularly over the body side end part joint portion and the outside member and set a width of the fusion bonded portion to at least 3 mm to 20 mm while including the inner peripheral edge of the body side end part joint portion. It is preferable to set the width of the fusion bonded portion of the inside member over the body side end part joint portion and the outside member between 3 mm and 20 mm since a sufficient sealing performance can not be secured if the width is too small, and a working time for the fusion bonding work becomes long if the width is too large. The fusion bonded portion can be structured such that the fusion bonding width between the inside member and the body side end part joint portion is different from the fusion bonding width between the inside member and the outside member, however, it is preferable to arrange the center in a width direction of the fusion bonded portion at a position corresponding to the inner peripheral edge of the body side end part joint portion so that the widths are the same.

(2) According to a preferable embodiment, a thickness of the film material of the inside member is set to be thinner than a thickness of the film material of the outside member, and one end opening portion of the body member is closed by the outside member. In other words, in the case that the one end opening portion of the body member is closed by the outside member, it is not necessary to apply the functions such as the gas barrier performance and the light blocking effect to the inside member. As a result, it is possible to construct the inside member thin without lowering the functions such as the gas barrier performance and the light blocking effect and without lowering the sealing performance by constructing the inside member thinner than the outside member, whereby it is possible to make a used amount of the synthetic resin material constructing the pouch container as small as possible.

(3) According to a preferable embodiment, one of the outside member and the inside member is comprised of the film material which can close the one end opening portion of the body member, and the other of the outside member and the inside member is comprised of the annular film material which is fusion bonded to the body side end part joint portion, and the one of the outside member and the inside member. In this case, since the other of the outside member and the inside member is comprised of the annular film material, it is possible to make the used amount of the synthetic resin material constructing the pouch container as small as possible.

(4) According to a preferable embodiment, the body side end part joint portion is formed into an annular shape by folding back one end portion of the body member outside and thereafter folding inside a portion which is reversed inside and outside by the folding back, and a portion which is arranged inside the portion. In this case, since the inside member and the outside member are fusion bonded to the synthetic resin layer in the inner surface side of the body member, it is possible to enhance a design freedom of an outermost surface of the body member in relation to a raw material of the synthetic resin layer. For example, it is possible to employ the synthetic resin layer made of the raw material which is excellent in the abrasion resistance for the synthetic resin layer in the outermost surface of the body member.

(5) According to a preferable embodiment, the width of the body side end part joint portion is set between 2 mm and 20 mm. Since the fusion bonding area of the body side end part joint portion to the outside member and the inside member can not be sufficiently secured if the width of the body side end part joint portion is too small, and the great wrinkle is formed in the inner peripheral edge of the body side end part joint portion if the width is too large, the width of the body side end part joint portion is preferably set between 2 mm and 20 mm.

The pouch container according to the present invention can be structured as follows.

According to a preferable embodiment, the body member is provided with a body side lateral part joint portion obtained by rolling up the film material constructing the body member into a tubular shape and butt seaming both ends thereof. In the case that the body side lateral part joint portion is formed by butt seaming the film material as mentioned above, the end portion of the film material constructing the body member is not exposed to the container in the side edge of the body side lateral part joint portion. As a result, since it is possible to securely prevent the adhesive agent from seeping into the content filled in the container from the end portion of the body side lateral part joint portion while employing the multilayer film using the adhesive agent as the film material constructing the body member, this structure is preferable. However, in the case that the body side lateral part joint portion is comprised of butt seaming, the body side lateral part joint portion protrudes outward from the peripheral surface of the body member so as to lower an outer appearance of the container and a hand feeling when holding by a hand is lowered. Therefore, it is preferable to improve the hand feeling when holding by a hand as well as improving the outer appearance of the container, by employing a film material forming sealant layers in both surfaces as the film material constructing the body member, fusion bonding the body side lateral part joint portion to the peripheral surface of the body member, and structuring such that the body side lateral part joint portion is smoothly connected to the peripheral surface of the body member. Further, in the case that the body side lateral part joint portion is fusion bonded to the peripheral surface of the body member, it is possible to manufacture a nice-looking cylindrical body member by rolling up the film material at the manufacturing time of the body member, and it is possible to finely fold the body side lateral part joint portion when the body side end part joint portion is formed by folding one end portion of the body member inside. As a result, it is possible to shorten a time for sealing between the body side end part joint portion and the closing member, and it is possible to prevent fault in fusion bonding between the body member and the closing member, so that it is possible to precisely attach the closing member to the body member. In the present specification, butt seaming means a bonding method of rolling up the film material and superposing the inner surface sides of both end portions thereof so as to fusion bond.

According to a preferable embodiment, the body member is provided with a body side lateral part joint portion obtained by rolling up the film material constructing the body member and envelope bonding both ends. In this case, since the body side lateral part joint portion hardly protrudes outward and is formed in the peripheral surface of the body member while being smoothly connected, it is possible to improve the hand feeling when holding by a hand as well as improving the outer appearance of the container. Further, since the body side lateral part joint portion can be folded finely at the manufacturing time of the body member, it is possible to shorten the time for sealing between the body member and the closing member, it is possible to prevent the fault in the fusion bonding, and it is possible to precisely attach the closing member to the body member. In the case that the body side lateral part joint portion is formed by envelope bonding the film material, the end portion of the film material constructing the body member is exposed to the container in the side edge of the body side lateral part joint portion. Therefore, it is preferable to structure such that the body member is comprised of the single layer film or the multilayer film according to the coextrusion method so as to prevent the adhesive agent from seeping into the content filled in the container from the side edge of the body side lateral part joint portion. In the present specification, envelop bonding means a bonding method of rolling up the film material and superposing an inner surface side of one end portion and an outer surface side of the other end portion so as to fusion bond.

According to a preferable embodiment, the film material constructing the body member is comprised of a film material of a multilayer structure having sealant layers which are provided in both surfaces, and one to a plurality of base material layers which are provided between both the sealant layers, and the film material constructing the closing member is comprised of a film material of a multilayer structure having a sealant layer which is provided in at least one outside surface, and a base material layer which is provided in a laminating manner in the sealant layer. According to the structure mentioned above, the outside member and the inside member can be fusion bonded as the closing member to the outer surface side of the body side end part joint portion which is formed in one end portion of the body member and protrudes inward. Further, the other end portion of the body member can be closed by the fusion bonding and the other end portion can be closed by the fusion bonding in a state in which a spout is arranged in the other end portion of the body member.

According to a preferable embodiment, a thickness of the sealant layer in the fusion bonded surface side between the body member and the closing member is set between 10 and 200 μm. In other words, since an endless annular body side end part joint portion protruding inward is formed in one end portion of the body member, one end portion of the body member is folded back to the inner side or the outer side at the forming time of the container main body. However, the wrinkle extending in a radial direction is unavoidably formed in the body side end part joint portion, and there is a risk that a seal defect is formed along the wrinkle when the outer peripheral portion of the closing member is fusion bonded to the body side end part joint portion. The sealant can be securely filled in a gap caused by the wrinkle generated in the fold-back portion by securing a sufficient amount of sealant between the joint portions at the bonding time between the body side end part joint portion and the outer peripheral portion of the closing member by setting the thickness of the sealant layer between 10 and 200 μm, thereby sufficiently securing a sealing performance between the body member and the closing member. Accordingly, this structure is preferable.

According to a preferable embodiment, a width of the fusion bonded portion between the body side end part joint portion and the closing member is set between 1 and 10 mm. In other words, in the case that the width of the fusion bonded portion between the body side end part joint portion and the closing member is less than 1 mm, a bonding strength between the body side end part joint portion and the closing member can not be sufficiently secured, and if it goes beyond 10 mm, a workability when the body side end part joint portion is formed by folding one end portion of the body member is lowered, and the outer appearance of the pouch container is lowered. As a result, it is preferable to set between 1 and 10 mm.

According to a preferable embodiment, a spout fusion bonding and retaining the main body portion is provided between the inner surfaces of the body member. In the pouch container according to the present invention, in the case that the spout is provided in the pouch container, the closing member is attached to one end portion of the body member and the spout is thereafter attached to the other end portion of the body member. Therefore, it is impossible to insert a jig into the body member so as to receive the spout at the attaching time of the spout. As a result, the spout is preferably structured such that a spout which can fusion bond and retain the main body portion between the inner surfaces of the body member is provided in a state in which a main body portion of the spout is arranged in the other end opening portion of the body member. For example, the spout can employ a boat-shaped spout having a boat-shaped main body portion which is the widest in its center portion and is narrower toward both end portion sides, and a tubular opening portion which is provided in a rising manner in the main body portion.

According to a preferable embodiment, a sealing performance improved structure is provided for improving the sealing performance between the body side end part joint portion and the closing member.

A second pouch container according to the present invention is a self-standing pouch container provided with a body member which is made of a film material, and a closing member which closes one end opening portion of the body member in a liquid tight manner and is made of a film material, wherein an annular body side end part joint portion is formed in one end portion of the body member by being folded inside, the closing member is provided with an outside member which is fusion bonded to an outer surface side of the container in the body side end part joint portion, and/or an inside member which is fusion bonded to an inner surface side of the container in the body side end part joint portion, and a sealing performance improved structure is provided for improving a sealing performance between the body side end part joint portion and the closing member.

In the pouch container according to the present invention, since the body side end part joint portion is formed by folding one end portion of the body member inside, the wrinkle extending in the radial direction is unavoidably formed in the body side end part joint portion, and there is a possibility that the sealing performance is lowered by the wrinkle in the fusion bonded portion between the body side end part joint portion and the closing member. As a result, it is preferable to improve the sealing performance between the body side end part joint portion and the fusion bonded member by the provision of the sealing performance improved structure like the second pouch container.

According to a preferable embodiment, a seal portion comprised of an annular protruding portion is formed in the fusion bonded portion between the body side end part joint portion and the closing member, and a seal portion is formed like a grid in the fusion bonded portion between the body side end part joint portion and the closing member, as the sealing performance improved structure. In this case, it is possible to further improve the sealing performance between the body side end part joint portion and the closing member. The seal portion mentioned above can be easily formed by using a pair of heating molds thermally fusion bonding the body side end part joint portion and the outer peripheral portion of the closing member while pinching the both, the molds being structured such that an annular or grid-like fitting groove is formed in a heating surface of one heating mold, and an annular or grid-like fitting protruding portion fitting in a concavo-convex manner to the fitting groove is formed in a heating surface of the other heating mold.

It is preferable to control the overlapping number of the film material due to the wrinkle in the body side end part joint portion to be two or less, by the sealing performance improved structure. If the overlapping number of the film material in the wrinkle becomes three or more, a step in a thickness direction between the wrinkle portion and both sides thereof becomes large, and the gap tends to be formed along the wrinkle. As a result, it is preferable to set the overlapping number due to the wrinkle of the film material to be two or less. However, in the case of employing the body member obtained by rolling up the film material into the tube shape and butt seaming or envelope bonding both end portions, the butt seamed or envelope bonded portion in the body side end part joint portion comes to a state in which two or more film materials are superposed. As a result, it is preferable to control the overlapping number of the other portions than the butt seamed portion and the envelope bonded portion to two or less by controlling so that any wrinkle is not formed in the butt seamed portion and the envelope bonded portion.

According to a preferable embodiment, a plurality of wrinkle collecting portions comprised of through holes are formed in a midstream portion in a width direction of the body side end part joint portion so as to be spaced in a peripheral direction, as the sealing performance improved structure. According to the structure mentioned above, since the through holes deform when the body side end part joint portion is formed by folding the end portion of the body member inside, it is possible to suppress the generation of the wrinkle in the body side end part joint portion, and it is possible to improve the sealing performance between the body side end part joint portion and the closing member. Further, it is possible to prevent the outer appearance of the pouch container from being lowered by the wrinkle even in the case that the body side end part joint portion is exposed to the external portion.

Further, in the case that the through holes are formed as mentioned above, it is preferable to arrange the center of the wrinkle collecting portion comprised of the through holes closer to the inner peripheral side than the center portion in the width direction of the body side end part joint portion. Since the magnitude of the wrinkle becomes larger toward the inner peripheral side of the body side end part joint portion, it is possible to further improve the sealing performance between the body side end part joint portion and the closing member, by arranging the center of the wrinkle collecting portion comprised of the through holes closer to the inner peripheral side than the center portion in the width direction of the body side end part joint portion so as to make the large wrinkle in the inner peripheral side of the body side end part joint portion small on the basis of the deformation of the through holes, or structuring such that the through holes are not formed in the outer peripheral side portion of the body side end part joint portion so as to fusion bond the outer peripheral side portion of the body side end part joint portion to the closing member with no gap.

According to a preferable embodiment, the sealing performance improved structure is obtained by forming a plurality of wrinkle collecting portions comprised of incisions extending from the midstream portion in the width direction of the body side end part joint portion to the inner peripheral edge so as to be spaced in the peripheral direction. According to the structure mentioned above, the inner peripheral portion of the body side end part joint portion is divided into a plurality of joint pieces by the incisions, and the adjacent joint pieces superpose. As a result, it is possible to prevent the wrinkle from being generated in the body side end part joint portion, it is possible to improve the sealing performance between the body side end part joint portion and the closing member, and it is possible to prevent the outer appearance of the pouch container from being lowered by the wrinkle even in the case that the body side end part joint portion is exposed to the external portion.

In the case that the incisions mentioned above are formed, it is preferable to form the wrinkle collecting portion comprised of the incisions so as to be angled in one direction in relation to a direction which is orthogonal to a tangential direction of the inner peripheral edge of the body side end part joint portion. According to the structure mentioned above, it is possible to prevent the wrinkle from being generated in the body side end part joint portion by controlling so that the overlapping number of the adjacent joint pieces as small as possible, thereby improving the sealing performance between the body side end part joint portion and the closing member. Further, it is possible to prevent the outer appearance of the pouch container from being lowered by the wrinkle even in the case that the body side end part joint portion is exposed to the external portion, and it is further possible to improve the design property of the pouch container on the basis of a regular incision in one direction.

The sealing performance improved structure can be obtained by forming a plurality of wrinkle collecting portions comprised of notches in the inner peripheral portion of the body side end part joint portion so as to be spaced in a peripheral direction. According to the structure mentioned above, since the inner peripheral portion of the body side end part joint portion is divided into a plurality of joint pieces by the notches, and the adjacent joint pieces come close in a direction that the notches are narrowed when the body side end part joint portion is formed by folding one end portion of the body member inside, it is possible to prevent the wrinkle from being generated in the body side end part joint portion, it is possible to improve the sealing performance between the body side end part joint portion and the closing member, and it is possible to prevent the outer appearance of the pouch container from being lowered by the wrinkle even in the case that the body side end part joint portion is exposed to the external portion. V-shaped notches, U-shaped notches, and isosceles trapezoidal notches can be formed as the notches.

The body side end part joint portion is preferably formed into an annular shape by a combination of a plurality of circular arcs having different radii of curvature, and it is preferable to set an arrangement pitch of the wrinkle collecting portions in a portion having a smaller radius of curvature to be smaller than an arrangement pitch of the wrinkle collecting portions in a portion having a larger radius of curvature. In the portion having the smaller radius of curvature of the body side end part joint portion, the greater wrinkle is formed than in the portion having the larger radius of curvature and a lot of wrinkles are formed, when the body side end part joint portion is formed by folding one end of the body member. As a result, it is preferable to structure such as to remove the wrinkles as many as possible by setting the arrangement pitch of the wrinkle collecting portions in the portion having the smaller radius of curvature.

According to a preferable embodiment, the sealing performance improved structure is comprised of a fusion bonding portion obtained by fusion bonding a fusion bonding portion in the inner peripheral side portion of the fusion bonded portion between the body side end part joint portion and the closing member at a higher temperature and a higher pressure than those of a fusion bonding portion in the outer peripheral side portion. The sealing performance is enhanced by fusion bonding the body side end part joint portion and the closing member at the high temperature and the high pressure, however, the film material constructing the body side end part joint portion and the closing member unavoidably tends to be deteriorated by heat. Accordingly, it is possible to sufficiently secure the sealing performance while preventing the film material from being thermally deteriorated as much as possible at the fusion bonding time, by fusion bonding the inner peripheral side portion where the greater wrinkle is formed, at the higher temperature and the higher pressure than in the outer peripheral side portion.

According to a preferable embodiment, the closing member is formed into an oval shape as well as a transverse section of the body member is formed into an oval shape, and the sealing performance improved structure is obtained by forming an inclined surface which is inclined diagonally to the other end portion side of the body member in an opposite side to the body side end part joint portion, in both end side portions of a major axis of the oval, in the fusion bonded portion of the oval annular shape between the body side end part joint portion and the closing member. In other words, since the radius of curvature becomes smaller in both end portions of the major axis of the oval in the body side end part joint portion than in the center portion of the major axis (both end portions of a minor axis) of the oval, a lot of wrinkles are formed in the portion when the body side end part joint portion is formed by folding one end portion of the body member inside. Accordingly, in the present invention, the body side end part joint portion is folded in two stages in both inner and outer edges of the inclined surface when the body side end part joint portion is formed by folding the one end portion of the body member inside, by forming the inclined surface which is inclined diagonally to the other end portion side of the body member in the opposite side to the body side end part joint portion, in both end side portions of the major axis of the oval in the oval annular fusion bonded portion between the body side end part joint portion and the closing member. As a result, it is possible to suppress the generation of the wrinkle and improve the sealing performance by reducing an angle of folding of the body side end part joint portion in comparison with the case of folding one time.

A manufacturing method of a pouch container according to the present invention is provided with a body member forming step which forms a body member made of a film material, and an end portion closing step which forms a body side end part joint portion by folding back one end portion of the body member inside, fusion bonds an outer peripheral portion of a closing member made of a film material to the body side end part joint portion, and attaches the closing member to one end portion of the body member so as to close one end opening of the body member in a liquid tight manner.

In the manufacturing method, since the body member and the closing member of the pouch container are made of the film materials, it is possible to manufacture the pouch container which can achieve volume reduction by crushing the body member and the closing member flat after the use of the content. Further, since the closing member is arranged in the one end portion of the container main body, and the annular joint portion which is harder than the body member and the closing member is formed in the outer peripheral portion of the closing member by fusion bonding the body side end part joint portion and the outer peripheral portion of the closing member, it is possible to manufacture the pouch container which is excellent in the self-standing stability. Further, since the body side end part joint portion and the outer peripheral portion of the closing member fusion bonded thereto do not protrude outward from the body member, it is possible to improve the design property of the pouch container. Further, since the work carried out in the body member forming step and the end portion closing step are comparatively easy works, it is possible to automate a bag making work.

According to a preferable embodiment, the end portion closing step is provided with a loading step which inward fits an attaching jig to the body member, a fold-back step which folds back one end portion of the body member protruding outward from one end portion of the attaching jig inside around one end edge of the attaching jig, and forms a body side end part joint portion comprised of an endless annular fold-back portion in the body member in one end side of the attaching jig, and a fusion bonding step which fusion bonds the film material constructing the closing member to the body side end part joint portion, and closes one end opening portion of the body member by the closing member in a liquid tight manner.

In the case that the end portion closing step is structured as mentioned above, since the body side end part joint portion comprised of the endless annular fold-back portion can be formed in the body member in the one end side of the attaching jig, by folding back the one end portion of the body member outward fitted to the attaching jig inside so as to be reversed inside and outside around the one end edge of the attaching jig, it is possible to efficiently form the body side end part joint portion in the one end portion of the body member. Further, since the fold-back work of the body member mentioned above can be automated comparatively easily, and the loading step and the fusion bonding step can be also automated comparatively easily, it is possible to automate a whole of the attaching step. Further, since the width of the body side end part joint portion comes to a corresponding magnitude to the width of the one end surface of the attaching jig, it is possible to sufficiently secure the width of the joint portion obtained by fusion bonding the body side end part joint portion and the outer peripheral portion of the closing member over a whole periphery, and it is possible to prevent the bonding strength and the liquid tightness from being lowered due to a partial reduction of the fusion bonding area.

### Advantageous Effects of Invention

On the basis of the pouch container according to the present invention, since the body member and the closing member of the pouch container are comprised of the film material, the volume of the pouch container can be reduced by crushing the body member and the closing member flat after the use of the content. Further, since the annular body side end part joint portion is formed by folding the one end opening portion of the body member inside and the outside member is fusion bonded to the outer surface side of the container in the body side end part joint portion, the wrinkle can be covered with the outside member even in the case that the wrinkle is generated at the folding time of the body side end part joint portion. As a result, it is possible to prevent the design property from being lowered by exposure of the wrinkle to the outer portion. Further, in the case that the bottom surface of the pouch container is comprised of the outside member, the bottom surface of the pouch container is comprised of the flat outside member. Therefore, the pouch container can be self-standing by installing approximately a whole of the lower surface of the outside member in the installation surface with no gap, and it is possible to improve the self-standing stability and the shape retention property of the pouch container. Further, since the body side end part joint portion and the outer peripheral portion of the outside member fusion bonded thereto do not protrude outward from the body member, it is possible to improve the design property of the pouch container.

Particularly, the closing member can be provided with the outside member, and an inside member which is fusion bonded to an inner surface side of the container of the body side end part joint portion, the inside member can be comprised of a single layer film or a multilayer film according to the coextrusion method, and the inside member can compart an inner peripheral edge of the body side end part joint portion so as not to be exposed to the container. In this case, since the closing member is comprised of the inside member and the outside member, the rigidity of the bottom surface of the pouch container is enhanced in the case that the bottom surface of the pouch container is comprised of the closing member, and it is possible to improve the self-standing stability and the shape retention property of the pouch container. Further, in the case that the upper surface of the pouch container is comprised of the closing member, it is possible to improve the shape retention property of the pouch container. Further, since the inside member employs the inside member comprised of the single layer film or the multilayer film according to the coextrusion method, it is possible to securely prevent the adhesive agent from seeping into the content filled in the container from the outer peripheral edge of the inside member like the case of using the multilayer film manufactured by the dry lamination method, in spite of the fact that the outer peripheral edge of the inside member is exposed to the container. Further, since the inner peripheral edge of the body side end part joint portion is comparted by the inside member so as not to be exposed to the container, it is possible to securely prevent the adhesive agent from seeping into the content filled in the container from the inner peripheral edge of the body side end part joint portion even in the case of using the multilayer film manufactured by the dry lamination method for the body member.

Further, the sealing performance between the body side end part joint portion and the closing member can be improved by forming the seal portion comprised of the annular protruding portion or the grid-like seal portion, as the sealing performance improved structure improving the sealing performance, in the fusion bonded portion between the body side end part joint portion and the closing member, or fusion bonding the inside portion of the fusion bonded portion at the higher temperature and the higher pressure than in the outer peripheral side portion, or protruding the inner peripheral side portion of the fusion bonded portion closer to the outer side of the container than in the outer peripheral side portion, or setting the wrinkle collecting portion comprised of the through holes, the incisions or the notches, or the incisions as the sealing performance improved structure improving the sealing performance in the body side end part joint portion, or optionally combining them. Further, since it is possible to reduce the wrinkle in the body side end part joint portion by forming the wrinkle collecting portion, it is possible to enhance a smoothness of the outside member which is fusion bonded to the body side end part joint portion so as to improve the outer appearance of the pouch container.

In the manufacturing method of the pouch container according to the present invention, since the body member and the closing member of the pouch container are made of the film materials, it is possible to manufacture the pouch container which can achieve volume reduction by crushing the body member and the closing member flat after the use of the content. Further, since the closing member is arranged in the one end portion of the container main body, and the annular joint portion which is harder than the body member and the closing member is formed in the outer peripheral portion of the closing member by fusion bonding the body side end part joint portion and the outer peripheral portion of the closing member, it is possible to manufacture the pouch container which is excellent in the self-standing stability. Further, since joint portion between the body side end part joint portion and the outer peripheral portion of the closing member does not protrude outward from the body member, the design property of the pouch container is not lowered by the joint portion. Further, since the work carried out in the body member forming step and the end portion closing step are comparatively easy works, it is possible to automate a bag making work.

### BRIEF DESCRIPTION OF THE DRAWINGS

FIG. 1 is a perspective view of a pouch container according to a first embodiment;

FIGS. 2(a), 2(b), and 2(c) are respectively a front elevational view, a right side elevational view, and a back elevational view of the pouch container;

FIG. 3 is a cross sectional view along a line III-III in FIG. 1;

FIG. 4 is a cross sectional view along a line IV-IV in FIG. 1;

FIG. 5 is a vertical cross sectional view of a substantial part of a lower end closing structure of the pouch container;

FIGS. 6(a) and 6(b) are views corresponding to FIG. 5 of the other lower end closing structure of the pouch container;

FIG. 7(a) is a vertical cross sectional view of a lower end closing structure having the other structure;

FIGS. 7(b) and 7(c) are explanatory views of a manufacturing method of the lower end closing structure having the other structure;

FIGS. 8(a) and 8(b) are vertical cross sectional views of a pouch container having the other structure;

FIGS. 9(a) and 9(b) are vertical cross sectional views of a pouch container having the other structure;

FIG. 10 is a perspective view of a body member before fusion bonding the closing member;

FIGS. 11(a) to 11(c) are explanatory views of a folding step;

FIG. 12 is an explanatory view of a closing member set step;

FIG. 13 is an explanatory view of a fusion bonding step;

FIG. 14 is an explanatory view of a spout fusion bonding step;

FIG. 15 is a perspective view of a pouch container according to a second embodiment;

FIGS. 16(a), 16(b), and 16(c) are respectively a front elevational view, a right side elevational view, and a back elevational view of the pouch container;

FIG. 17 is a cross sectional view along a line XVII-XVII in FIG. 15;

FIG. 18 is a cross sectional view along a line XVIII-XVIII in FIG. 15;

FIGS. 19(a) and 19(b) are views corresponding to FIG. 17 of the other lower end closing structure of the pouch container;

FIGS. 20(a) and 20(b) are vertical cross sectional views of a pouch container having the other structure;

FIGS. 21(a) and 21(b) are vertical cross sectional views of the pouch container having the other structure;

FIG. 22 is a view corresponding to FIG. 17 of the pouch container having the other structure;

FIG. 23 is a view corresponding to FIG. 18 of the pouch container;

FIG. 24 is an explanatory view of a body portion forming step;

FIGS. 25(a) to 25(e) are explanatory views of a lower end closing step;

FIG. 26 is an explanatory view of a spout attaching step;

FIG. 27 is a view corresponding to FIG. 17 of a pouch container having the other structure;

FIG. 28 is a view corresponding to FIG. 18 of the pouch container;

FIGS. 29(a) to 29(d) are explanatory views of a lower end closing step of the pouch container;

FIGS. 30(a) and 30(b) are explanatory views of a reversing step of the pouch container;

FIG. 31(a) is a bottom elevational view of an annular body side end part joint portion in which a through hole is formed;

FIG. 31(b) is a bottom elevational view of an oval annular body side end part joint portion in which a through hole is formed;

FIG. 32(a) is a bottom elevational view of an annular body side end part joint portion in which an incision is formed;

FIG. 32(b) is a bottom elevational view of an oval annular body side end part joint portion in which an incision is formed;

FIG. 33(a) is a bottom elevational view of an annular body side end part joint portion in which an incision is angled;

FIG. 33(b) is a bottom elevational view of an oval annular body side end part joint portion in which an incision is angled;

FIG. 34(a) is a bottom elevational view of an annular body side end part joint portion in which a notch is formed;

FIG. 34(b) is a bottom elevational view of an oval annular body side end part joint portion in which a notch is formed;

FIG. 35(a) is a bottom elevational view of an oval annular body side end part joint portion in which an incision and a notch are formed;

FIG. 35(b) is a bottom elevational view of an oval annular body side end part joint portion in which an incision and a through hole are formed;

FIG. 36(a) is a bottom elevational view of a container main body which is provided with a wrinkle collecting structure;

FIG. 36(b) is a cross sectional view along a line b-b in FIG. 36(a);

FIG. 37(a) is a bottom elevational view of a container main body in a state in which a closing member is fusion bonded so that a fusion bonding portion is formed at a high temperature and a high pressure;

FIG. 37(b) is an explanatory view of a fusion bonding method of the closing member;

FIG. 38(a) is a bottom elevational view of a container main body in a state in which the closing member is fusion bonded so that a seal portion is formed; and

FIG. 38(b) is an explanatory view of a fusion bonding method of the closing member.

### DESCRIPTION OF EMBODIMENTS

A description will be given below of embodiments according to the present invention with reference to the accompanying drawings.

### First Embodiment

First of all, a description will be given of a pouch container in which a closing member is comprised of an outside member and an inside member;

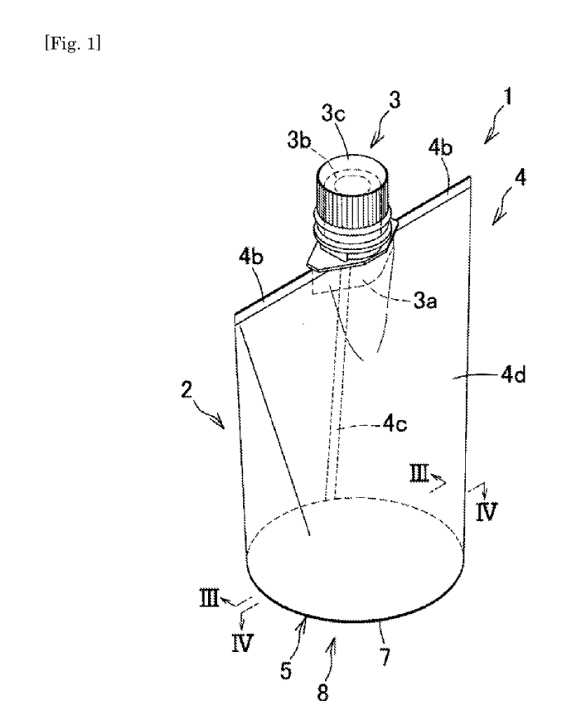

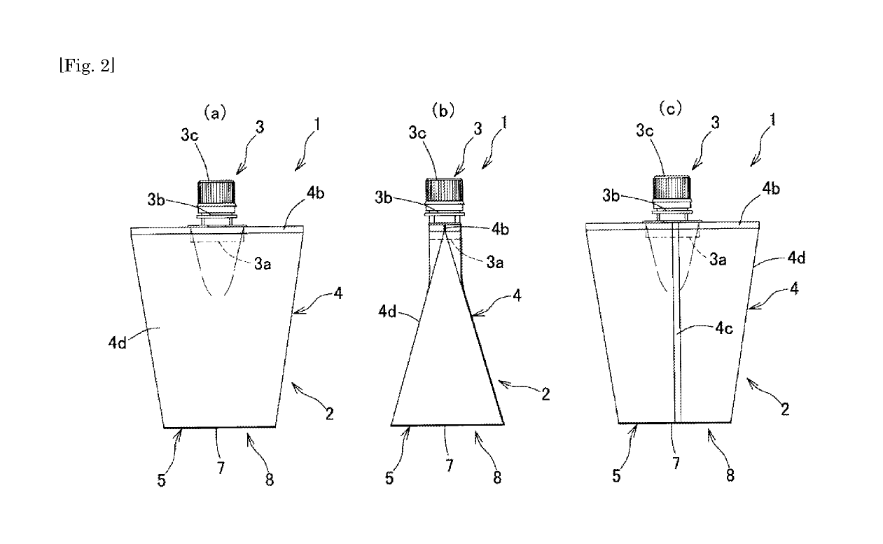

As shown in FIGS. 1 to 5, a pouch container 1 is provided with a container main body 2 which can accommodate a content and is comprised of a soft film, and a spout 3 which is fusion bonded to an upper end portion of the container main body 2. The container main body 2 is provided with a tubular body member 4, and a lower end closing member 5 which closes a lower end opening of the body member 4 in a liquid tight manner, a body side lower end joint portion 4a is formed as an annular body side end part joint portion which is bent inside, in a lower end portion of the body member 4, there are provided an inside member 6 which is fusion bonded to an inner surface side of the container main body 2 of the body side lower end joint portion 4a, and an outside member 7 which is fusion bonded to an outer surface side of the container main body 2 of the body side lower end joint portion 4a, as the lower end closing member 5, a structure comprised of a single layer film or a multilayer film according to a coextrusion method is employed as the inside member 6, and the container main body 2 is comparted by the inside member 6 so that an inner peripheral edge of the body side lower end joint portion 4a is not exposed to the container main body 2. The pouch container 1 is structured such as to be self-standing by installing approximately a whole surface of the lower surface of the outside member 7 in an installation surface, and is structured such that a waste material can be volume-reduced by folding or manually collapsing the body member 4 and the lower end closing member 5 after the use of the content.

The film material constructing the body member 4 and the outside member 7 is comprised of a soft film having a single layer or multilayer structure which can be volume-reduced manually. The film material can be comprised of a single layer film, however, it is possible to employ a multilayer film which is manufactured by a lamination method by an adhesive agent such as an adhesive agent lamination, for example, a dry lamination, a wet lamination, and a hot melt lamination, and an extrusion lamination, for example, a single lamination, a tandem lamination, and a coextrusion lamination, and a method using no adhesive agent such as a coextrusion method, for example, a thermal lamination, a T-die method, and an inflation method, in order to apply functions such as a gas barrier performance, a light blocking effect, and an abrasion resistance. Particularly, in the present invention, since end portions of the body member 4 and the outside member 7 are not exposed to the pouch container 1, and it is possible to prevent the adhesive agent constructing the film material from seeping into the content, it is possible to preferably employ the multilayer film according to the lamination method using the adhesive agent, as the film material constructing the body member 4 and the outside member 7. Specifically, the film material constructing the body member 4 can preferably employ a multilayer film having three layers or more in which sealant layers are provided in both surfaces, the sealant layer being capable of fusion bonding to each other by a heat seal, an ultrasonic seal, or the like, and being made of a thermoplastic synthetic resin material such as a polyolefin resin, and one or a plurality of base material layers are provided between both the sealant layers, the base material layer being made of a functional material, for example, an aluminum foil which has functions such as a gas barrier performance, a light blocking effect, and an abrasion resistance in correspondence to the content accommodated in the pouch container 1. Further, as the film material constructing the outside member 7, it is possible to preferably employ a multilayer film having two or more layers in which a sealant layer is provided in an inner surface side, the sealant layer being capable of fusion bonding to each other by the heat seal, the ultrasonic seal, or the like and being made of the thermoplastic synthetic resin material such as the polyolefin resin, and one or a plurality of base material layers are provided in an outer surface side, the base material layer being made of a functional material, for example, an aluminum foil which has functions such as the gas barrier performance, the light blocking effect, and the abrasion resistance. As the film material constructing the body member 4 and the outside member 7, it is possible to employ any structure as long as the structure can be volume-reduced manually and can be fusion bonded to the film material including the inside member 6 and the spout 3.

The film material constructing the inside member 6 is comprised of the single layer film or the multilayer film according to the coextrusion method, which can be volume-reduced manually. In the case that the film material is comprised of the multilayer film, it is preferable to employ the multilayer film which is manufactured without using any adhesive agent, such as the thermal lamination method, the T-die method, and the inflation method. In other words, since the inside member 6 is arranged within the pouch container 1 and the outer peripheral edge thereof is exposed to the pouch container 1, the adhesive agent may seep into the content filled in the pouch container 1 from the outer peripheral end portion of the inside member 6 in the case of the multilayer film which is manufactured by using the adhesive agent, for example, the dry lamination method. As a result, it is preferable to employ the multilayer film using no adhesive agent.

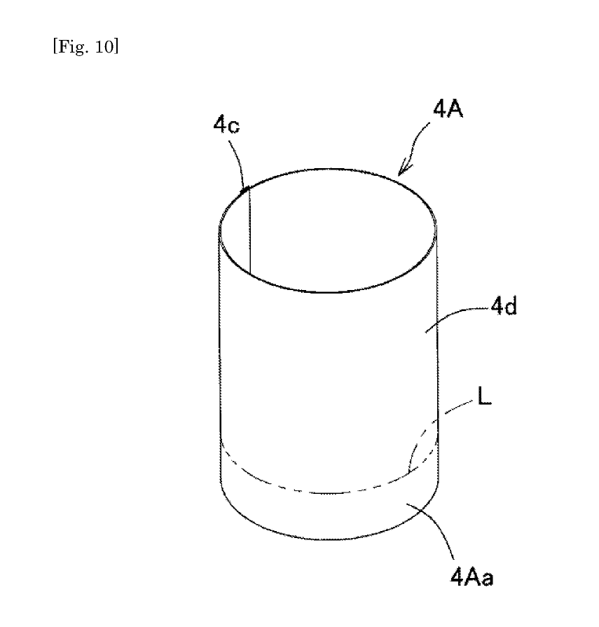

The body member 4 is formed by crushing an upper end portion of a body member 4A (refer to FIG. 10) comprised of a cylindrically formed film material into a flat shape, is formed approximately into a circular shape in its lower end portion, and is formed into a flat transverse sectional shape which is narrowed in a back and forth width from the lower end portion toward the upper side, and is structured such that a body side upper end joint portion 4b obtained by fusion bonding the film materials in a front surface side and a rear surface side is formed in the upper end portion, and the spout 3 is fusion bonded and retained between the film materials in the front surface side and the rear surface side in a midstream portion in a length direction (a lateral direction) of the body side upper end joint portion 4b. The body member 4 is formed into a tubular shape by rolling up one film material into a cylindrical shape, superposing both end portions, and bonding both end portions by a butt seaming or an envelope bonding according to a heat seal, an ultrasonic seal, or the like, and a body side lateral part joint portion 4c obtained by bonding the film material is formed in an outer side of the center portion in the lateral direction of the rear surface of the body member 4 over a whole length in a height direction. In the butt seaming, the film material is rolled up and is bonded by superposing both the end portions in their inner surface sides and fusion bonding them. However, since the end portion of the film material constructing the body member 4 is not exposed to the container in a side edge of the body side lateral part joint portion 4c, it is possible to securely prevent the adhesive agent from seeping into the content filled in the container from the end portion of the body side lateral part joint portion 4c while employing the multilayer film using the adhesive agent as the film material constructing the body member 4. Accordingly, this structure is preferable. Here, in the case that the body side lateral part joint portion 4c is comprised of the butt seaming, the body side lateral part joint portion 4c protrudes outward from the peripheral surface of the body member 4 so as to lower an outer appearance of the container, and a hand feeling when holding by a hand is lowered. Therefore, it is preferable to improve the hand feeling when holding by a hand as well as improving the outer appearance of the container, by using the film material constructing the body member 4 as the film material in which the sealant layers are formed in both surfaces, fusion bonding the body side lateral part joint portion 4c to the peripheral surface of the body member 4, and constructing so that the body side lateral part joint portion 4c is smoothly connected to the peripheral surface of the body member 4. Further, in the case that the body side lateral part joint portion 4c is fusion bonded to the peripheral surface of the body member 4, it is possible to manufacture a nice cylindrical body member 4A (refer to FIG. 10), and it is possible to finely bend the body side lateral part joint portion 4c when the body member 4A is set to a mandrel 30 and a body side lower end joint portion 4Aa is bent inward, as shown in FIG. 11. As a result, it is possible to shorten a time for sealing between the body member 4A and the lower end closing member 5, it is possible to prevent a fusion bonding defect, and it is possible to precisely attach the lower end closing member 5 to the body member 4A. Further, in the envelope bonding, the film material is rolled up, and is bonded by superposing an inner surface side of one end portion of the film material and an outer surface side of the other end portion and fusion bonding them. However, since the body side lateral part joint portion hardly protrude outward, and is formed so as to be smoothly connected to the peripheral surface of the body member, it is possible to improve the hand feeling when holding by the hand as well as improving the outer appearance of the container, and it is possible to finely bend the body side lateral part joint portion at the manufacturing time of the body member. As a result, it is possible to shorten the time for sealing between the body member and the lower end closing member, it is possible to prevent the fusion bonding defect, and it is possible to precisely attach the lower end closing member to the body member. In the case that the body side lateral part joint portion is formed by envelope bonding the film material, the end portion of the film material constructing the body member is exposed to the container in the side edge of the body side lateral part joint portion. As a result, it is preferable to structure such as to prevent the adhesive agent from seeping into the content filled in the container from the side edge of the body side lateral part joint portion, by constructing the body member by the single layer film or the multilayer film according to the coextrusion method. The body side lateral part joint portion 4c can be formed at an optional position in the peripheral direction of the body member 4.

In the pouch container 1 according to the first embodiment, the lower end portion of the body member 4 is formed into the circular shape, however, may be formed into an oval shape, a flat circular shape, a streamline, or a polygonal shape such as a quadrangular shape and a hexagonal shape. Further, the body member 4 is formed into the flat cross sectional shape which is narrowed in its back and forth width from the lower end portion toward the upper side, however, may be structured as a tubular shape having the same cross sectional shape as the lower end portion of the body member from the lower end portion to the upper end portion of the body member by provision of an upper end closing member which closes an upper end opening portion of the body member and is comprised of a film material, or may be structured such as to gently diameter-reduce only the upper end portion of the body member by forming the body member from the lower end portion to the upper portion into the tubular shape having the same cross sectional shape as the lower end portion of the body member. Further, it is possible to structure the body member into a frustum of circular cone or a frustum of pyramid, or form a constriction portion in the midstream portion of the body member, thereby structuring the pouch container such as to be easily held and enhancing the self-standing stability, the functionality, and the design property of the pouch container. Further, in order to easily fold the body member, it is possible to form a plurality of fold lines extending in a vertical direction in the midstream portion in the peripheral direction of the body member or form a gusset. Further, the body member 4 is constructed into the tubular shape by rolling up one film material and fusion bonding both the end portions thereof, however, it is possible to employ a body member obtained by superposing two film materials and fusion bonding side portions thereof, or bonding three or more film materials. Further, as the film material constructing the body member, it is possible to employ a tubular inflation film which is formed by an inflation molding, and it is possible to manufacture a body member having no body side lateral part joint portion 4c in this case.

The spout 3 is comprised of a boat-shaped spout provided with a boat-shaped main body portion 3a which is formed so as to be the widest in a center portion and be narrower toward both end portion sides and has a height in a plan view, a tubular opening portion 3b which is provided in a rising manner in the main body portion 3a, and a lid body 3c which is threadably engaged detachably with the opening portion 3b, as shown in FIGS. 1, 2, and 14. The spout can employ the other structures in correspondence to a structure of the pouch container as mentioned later, and can be omitted.

Next, a description will be given of a lower end closing structure 8 which closes the lower end opening portion of the body member 4.

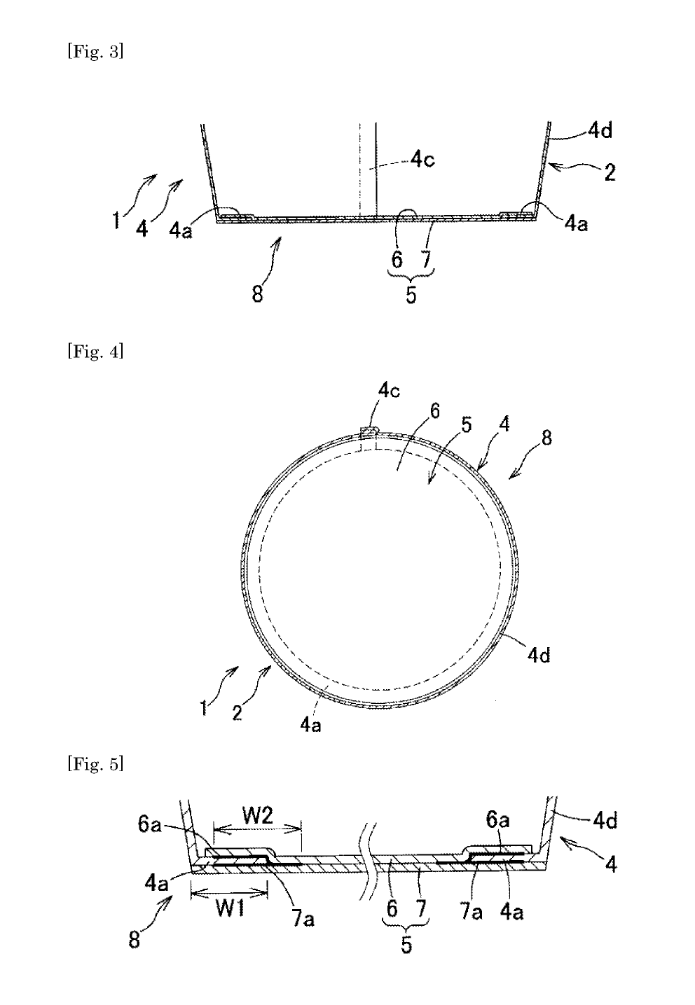

As shown in FIGS. 3 to 5, a lower end portion of the body member 4 is provided with the collar-like body side lower end joint portion 4a which protrudes inward and is formed into an endless ring shape, by bending inside. An inner portion of the lower end portion of the body member 4 is provided with an inside member 6 which has approximately the same size as an inner diameter of the lower end portion of the body member 4 and is comprised of a circular film material, the lower end portion of the body member 4 is provided with an outside member 7 which has approximately the same size as an outer diameter of the lower end portion of the body member 4 and is comprised of a circular film material, and the lower end closing member 5 closing the lower end opening portion of the body member 4 is comprised of the inside member 6 and the outside member 7.

An outer peripheral portion of the inside member 6 is provided so as to be superposed on an upper side of the body side lower end joint portion 4a, an outer peripheral portion of the outside member 7 is provided so as to be superposed on a lower side of the body side lower end joint portion 4a, an outer peripheral portion of the inside member 6 and an outer peripheral portion of the outside member 7 are bonded to the body side lower end joint portion 4a by the heat seal, the ultrasonic seal, or the like, the outer peripheral portion of the inside member 6 and the outer peripheral portion of the outside member 7 are bonded by the heat seal, the ultrasonic seal, or the like in the inner side of the body side lower end joint portion 4a, an annular inside fusion bonding portion 6a extending over the body side lower end joint portion 4a and the outside member 7 is formed in the inside member 6, and an annular outside fusion bonding portion 7a extending over the body side lower end joint portion 4a and the inside member 6 is formed in the outside member 7. By the provision of the inside fusion bonding portion 6a and the outside fusion bonding portion 7a, it is possible to doubly seal the lower end portion of the pouch container 1, and it is possible to secure the sealing performance by the outside fusion bonding portion 7a even in the case that the fusion bond defect is generated in the inside fusion bonding portion 6a. The inside member 6 and the outside member 7 in the inner side of the body side lower end joint portion 4a can be fusion bonded over a whole surface, and can be structured such that they are not fusion bonded. Further, a portion which is not fusion bonded can be provided between the fusion bonded portion of the inside member 6 and the outside member 7, and the fusion bonded portion of the inside member 6 and the body side lower end joint portion 4a, and/or the fusion bonded portion of the outside member 7 and the body side lower end joint portion 4a.

Since it is impossible to sufficiently secure a fusion bonding area of the body side lower end joint portion 4a to the outside member 7 and the inside member 6 if a width W1 of the body side lower end joint portion 4a is too small, and a great wrinkle is formed in an inner peripheral edge of the body side lower end joint portion 4a and the seal defect tends to be generated if the width W1 is too large, the width W1 of the body side lower end joint portion 4a is preferably set between 2 mm and 20 mm. Further, a thickness of the sealant layer of the soft film constructing the body member 4, the inside member 6, and the outside member 7 is preferably set between 10 μm and 200 μm so that the films are securely fusion bonded with no seal defect.

If a width W2 of the outside fusion bonding portion 7a and the inside fusion bonding portion 6a is too small, a sufficient sealing performance can not be secured, and if it is too large, a working time for the fusion bonding work is elongated. As a result, it is preferable to set the width W2 between 3 mm and 20 mm. The widths of the outside fusion bonding portion 7a and the inside fusion bonding portion 6a may be set to different widths. Further, the outside fusion bonding portion 7a and the inside fusion bonding portion 6a can be structured such that a fusion bonded width to the body side lower end joint portion 4a is different from a fusion bonded width to the inside member 6 or the outside member 7, however, it is preferable to arrange the center in the width direction of the fusion bonding portions 6a and 7a at a position corresponding to an inner peripheral edge of the body side lower end joint portion 4a so that the widths are the same. Further, according to a preferable embodiment, the sealing performance is enhanced by forming one seal portion or a plurality of seal portions each of which is comprised of an annular concave portion or protruding portion over a whole periphery, in the midstream portion in the width direction of the outside fusion bonding portion 7a and the inside fusion bonding portion 6a.

A thickness of the film material of the inside member 6 may be structured such as to be equal to a thickness of the film material of the outside member 7, however, it is preferable to structure such that the thickness of the film material of the inside member 6 is thinner than the thickness of the film material of the outside member 7 for making a used amount of the synthetic resin material as small as possible. In this case, it is structured such that the lower end opening portion of the body member 4 can be closed by at least the outside member 7.

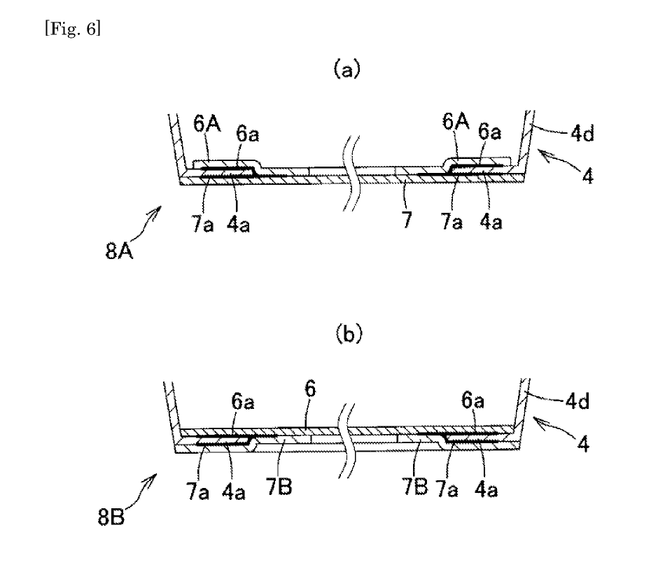

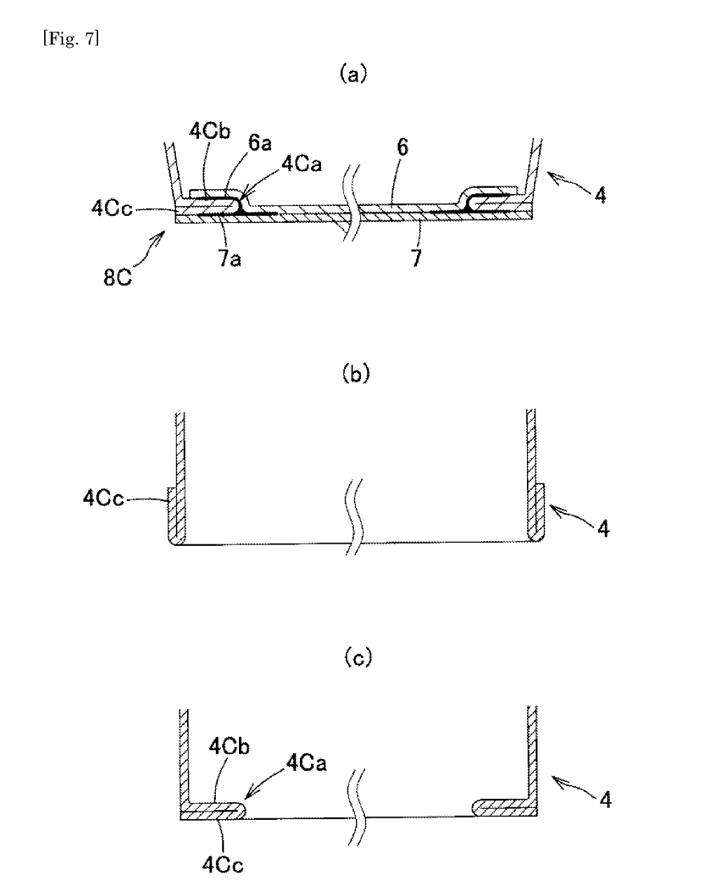

In the pouch container 1 according to the first embodiment, the inside member 6 and the outside member 7 are formed into a discoid shape, however, it is possible to structure, like a lower end closing structure 8A shown in FIG. 6(a), such as to set an inside member 6A which is comprised of an annular film material having a width capable of covering an inner peripheral edge of the body side lower end joint portion 4a, in place of the inside member 6, and fusion bond the inside member GA over the body side lower end joint portion 4a and the outside member 7 so as to cover the inner peripheral edge of the body side lower end joint portion 4a, or it is possible to structure, like a lower end closing structure 8B shown in FIG. 6(b), such as to set an outside member 7B which is comprised of an annular film material having a width capable of covering the inner peripheral edge of the body side lower end joint portion 4a, in place of the outside member 7, and fusion bond the outside member 7B over the body side lower end joint portion 4a and the inside member 6 so as to cover the inner peripheral edge of the body side lower end joint portion 4a. Further, it is possible to form a body side lower end joint portion 4Ca comprised of an annular inward bent portion 4Cb which is bent inside, and an annular outward bent portion 4Cc which is obtained by folding back an outer peripheral edge of the inward bent portion 4Cb outside, in place of the body side lower end joint portion 4a, in the lower end portion of the body member 4, fusion bond the outer peripheral portion of the inside member 6 to an upper side of the inward bent portion 4Cb, fusion bond the outer peripheral portion of the outside member 7 to a lower side of the outward bent portion 4Cc, and fusion bond the outer peripheral portion of the inside member 6 and the outer peripheral portion of the outside member 7 in the inner side of the body side lower end joint portion 4Ca, like a lower end closing structure 8C shown in FIG. 7(a). In order to form the lower end closing structure 8C, first of all, the body member 4 having the outward bent portion 4Cc is manufactured, as shown in FIG. 7(b), by folding back the lower end portion of the cylindrical body member 4A as shown in FIG. 10 outside, the body member 4 forming the annular body side lower end joint portion 4Ca comprised of the outward bent portion 4Cc and the inward bent portion 4Cb is thereafter manufactured by bending the outward bent portion 4Cc and the inward bent portion 4Cb arranged inside the outward bent portion inside as shown in FIG. 7(c), and the lower end closing structure 8C as shown in FIG. 7(a) is next formed by superposing and fusion bonding the outer peripheral portions of the inside member 6 and the outside member 7 on the body side lower end joint portion 4Ca. In the lower end closing structure 8C, since the inside member 6 and the outside member 7 are fusion bonded to the synthetic resin layer in the inner surface side of the body member 4, it is possible to employ a film material having a double layer structure in which the outer surface side sealant layer is omitted as the film material constructing the body member 4.

Further, the outer shapes of the inside member 6 and the outside member 7 are formed into a shape which conforms to the lower end portion of the body member 4, and in the case that the lower end portion of the body member 4 is formed into the oval shape, the flat circular shape, the streamline, or the polygonal shape such as the quadrangular shape and the hexagonal shape, the outer shapes are formed into a shape which conforms it. Further, it is preferable to form a fold line for folding in the inside member 6 and the outside member 7 so that the lower end closing member 5 can be easily folded when the body member 4 is folded.

In the pouch container 1, since the pouch container 1 can be self-standing vertically by installing a whole of the lower surface of the outside member 7 in the installation surface, it is possible to enhance the self-standing stability and the shape retention property of the pouch container 1. Further, since the body side lower end joint portion 4a, the outside member 7, and the inside member 6 are provided in the lower end portion of the container main body 2, and the bottom surface of the pouch container 1 is reinforced, the self-standing stability and the shape retention property of the pouch container 1 are further enhanced. Further, since the body member 4 and the lower end closing member 5 are comprised of the film material, it is possible to volume-reduce the pouch container 1 by crushing the body member 4 and the lower end closing member 5 flat after the use of the content. Further, since the lower end closing structure 8 obtained by fusion bonding the outer peripheral portions of the inside member 6 and the outside member 7 to the body side lower end joint portion 4a does not protrude out of the main body portion 4d of the body member 4, it is possible to prevent the design property of the pouch container 1 from being lowered by the outward protrusion of the outer peripheral portions of the inside member 6 and the outside member 7 and the body side lower end joint portion 4a from the main body portion 4d of the body member 4.

Next, a description will be given of the other embodiment in which the structure of the pouch container 1 is partly changed. A detailed description of the same members as those of the first embodiment will be omitted by attaching the same reference numerals.

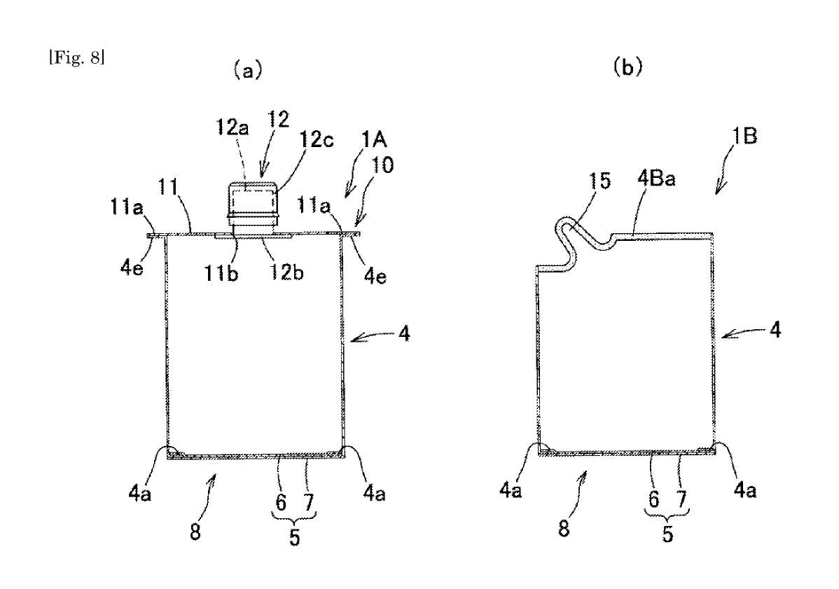

The lower end portion of the body member 4 can be closed by the same lower end closing structure 8 as mentioned above, and the upper end portion of the body member 4 can be closed by a closing structure 10 having the following structure, like a pouch container 1A shown in FIG. 8(a). In other words, an upper end opening of the body member 4 can be closed by an upper end closing member 11 by forming an annular collar portion 4e which extends outward in the upper end portion of the body member 4, setting the upper end closing member 11 which is comprised of the same soft film as the outside member 7, and fusion bonding an outer peripheral joint portion 11a of the upper end closing member 11 to an upper surface of the collar portion 4e. In this case, a spout 12 is used in place of the spout 3, the spout 12 having a cylindrical opening portion 12a, an annular flange portion 12b which protrudes outward from the opening portion 12a, and a lid member 12c which is attached to the opening portion 12a, and the spout 12 is attached by inserting the opening portion 12a to a through hole 11b which is formed in the center portion of the upper end closing member 11 from a lower side, and fusion bonding the flange portion 12b to the lower surface of the upper end closing member 11.

Further, the present invention can be applied to a pouch container which does not have the spout 3. For example, like a pouch container 1B shown in FIG. 8(b), a body side upper end joint portion 4Ba can be formed by closing the lower end portion of the body member 4 by the same lower end closing structure 8 as mentioned above, integrally forming a pouring portion 15 in the upper end portion of the body member 4, and superposing and fusion bonding an upper edge of the body member 4, and the content can be taken out by cutting a leading end portion of the pouring portion 15.

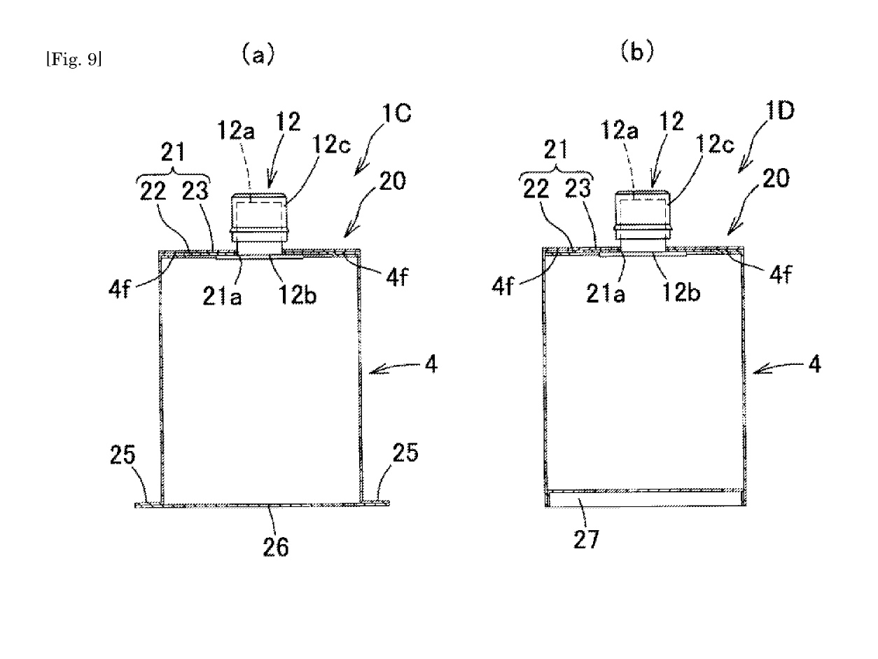

Further, like pouch containers 10 and 1D in FIGS. 9(a) and 9(b), the upper end portion of the body member 4 can be closed by an upper end closing structure 20 having the same structure as the lower end closing structure 8. Specifically, like the upper end closing structure 20 shown in FIGS. 9(a) and 9(b), the spout 12 can be attached to an upper end closing member 21 by forming a collar-like body side upper end joint portion 4f which protrudes inward and is formed into an endless annular shape in the upper end portion of the body member 4 according to the inward bending, setting the upper end closing member 21 which closes the upper end opening portion of the body member 4 in a liquid tight manner, setting an inside member 22 which is fusion bonded to an inner surface side of the body side upper end joint portion 4f, and an outside member 23 which is fusion bonded to an outer surface side of the body side upper end joint portion 4f, as the upper end closing member 21, constructing the inside member 22 and the outside member 23 by the same film material as that of the inside member 6 and the outside member 7, comparting by the inside member 22 so that an inner peripheral edge of the body side lower end joint portion 4a is not exposed to the pouch container 10, forming a through hole 21a in the center portion of the upper end closing member 21, and inserting the opening portion 12a of the spout 12 to the through hole 21a from a lower side in the same manner as the pouch container 1A in FIG. 8(a). Further, the lower end opening portion of the pouch container 1 can be provided with a lower end closing member 26 which is comprised of the same soft film as the lower end closing member 5, by forming an annular collar portion 25 extending outward in the lower end portion of the body member 4 and fusion bonding the outer peripheral portion to the lower surface of the annular collar portion 25, like a pouch container 1C in FIG. 9(a), or can be fusion bonded by a bottom member 27 which is comprised of the soft film material and has a well-known structure, in an inner side of the lower end portion of the body member 4, like a pouch container 1D in FIG. 9(b).

### <Manufacturing Method of Pouch Container>

Next, a description will be given of an example of a manufacturing method of the pouch container 1.

The manufacturing method of the pouch container 1 is provided with a body member forming step which forms the cylindrical body member 4A comprised of the film material, a lower end closing step which fusion bonds the lower end closing member 5 comprised of the inside member 6 and the outside member 7 to the lower end portion of the body member 4A, and a spout attaching step which attaches the spout 3 to the upper end portion of the body member 4A.

(Body Member Forming Step)

In the body member forming step, the cylindrical body member 4A is formed by rolling up the film material into the cylindrical shape, superposing both end portions, and bonding both end portions by the heat seal, the ultrasonic seal, or the like, as shown in FIG. 10. The body side lateral part joint portion 4c is formed in the formed body member 4A over a whole length in the height direction, the body side lateral part joint portion 4c being obtained by bonding both end portions of the film material by the butt seaming or the envelope bonding. The tubular inflation film formed by the inflation molding can be employed as the film material constructing the body member 4A. Further, it is possible to employ the tubular body member obtained by superposing two film materials and fusion bonding their side portions, or bonding three of more film materials. Further, in the case that the body member 4 of the pouch container 1 is formed into the polygonal shape, the cylindrical body member 4A is bent into the polygonal shape.

(Lower End Closing Step)

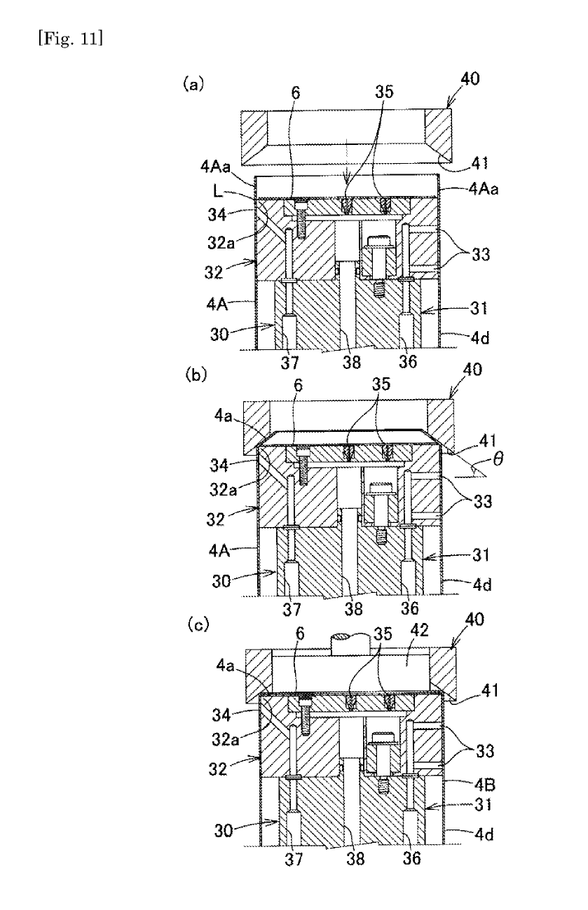

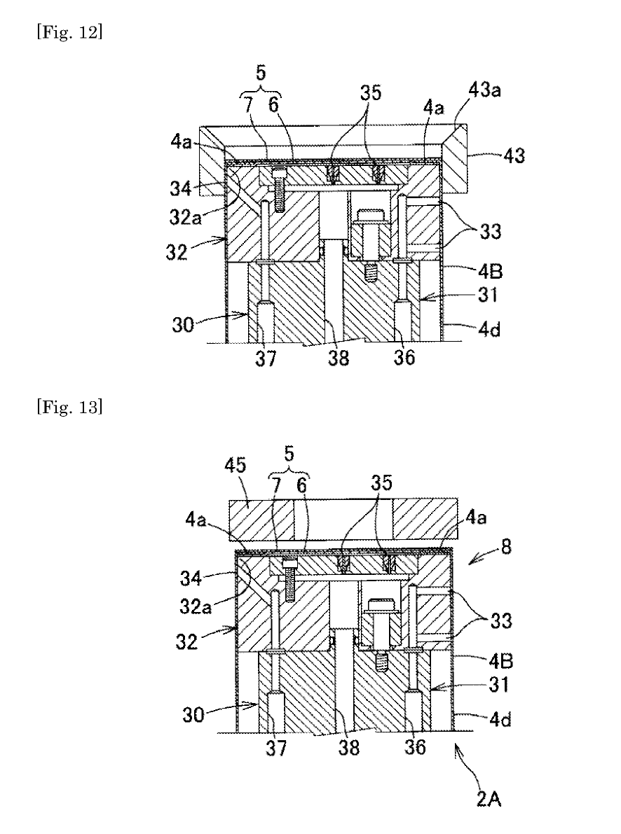

In the lower end closing step, first of all, the body member 4A is set like an outward fitting manner to the mandrel 30, and the inside member 6 is set to the upper surface of the mandrel 30, in the set step, and the tubular body side lower end joint portion 4Aa of the body member 4A is folded inside thereafter in the folding step so as to be temporarily fixed, as shown in FIG. 11. Next, the outside member 7 is set to an appropriate position on the folded body side lower end joint portion 4a in the outside member setting step, as shown in FIG. 12. Next, in the fusion bonding step, the outer peripheral portions of the inside member 6 and the outside member 7 are fusion bonded to the body side lower end joint portion 4a, the inside member 6 and the outside member 7 are fusion bonded in the inner side of the body side lower end joint portion 4a, the inside fusion bonding portion 6a and the outside fusion bonding portion 7a are formed, and the lower end closing member 5 is formed in the lower end portion of the body member 4, as shown in FIG. 13.

A description will be specifically given below of the lower end closing step, however, a description will be first given of the mandrel 30 which is used in the lower end closing step.

As shown in FIGS. 11 to 13, the mandrel 30 is provided with a columnar main body member 31, and a head member 32 which is arranged in an upper end portion of the main body member 31. An outer peripheral edge of the head member 32 is arranged outside an outer peripheral edge of the main body member 31, and the head member 32 is structured such as to be inward fitted to an inner surface of the body member 4A approximately with no gap. The head member 32 is detachably mounted to an upper end portion of the main body member 31 in such a manner as to be replaceable by a head member having a shape which conforms to a shape of the body member 4A of the manufactured pouch container 1.

Plural sets of pairs of upper and lower outer peripheral adsorption holes 33 are formed in an outer peripheral portion of the head member 32 so as to be spaced in a peripheral direction, air blowout holes 34 open toward a diagonally upper side are formed in a vicinity portion of the upper end of the head member 32 so as to be spaced in a peripheral direction, and a plurality of upper surface adsorption holes 35 are formed in an upper surface of the head member 32. A plurality of air suction paths 36, a plurality of air supply paths 37, and one air suction path 38 are formed in the main body member 31, the air suction paths 36 being communicated respectively with the plural sets of outer peripheral adsorption holes 33, the air supply paths 37 being communicated with each of the air blowout holes 34, and the air suction path 38 being communicated with the upper surface adsorption hole 35.

In the setting step, the body member 4A is loaded to the mandrel 30 by loading the body member 4A to the mandrel 30 in a reversing manner and an outward fitting manner so that the body side lower end joint portion 4Aa is arranged in the upper side, positioning a boundary portion L between the main body portion 4d of the body member 4A and the body side lower end joint portion 4Aa connected to the main body portion 4d at a corner portion 32a for bending in an upper end outer peripheral edge of the head member 32 of the mandrel 30, and inserting the body member 4A while blowing out the air from the air blowout hole 34 so as to assist the insertion of the body member 4A into the mandrel 30, as shown in FIG. 11(a). Next, the inside member 6 is loaded to the inner side of the body member 4A so as to be mounted on the mandrel 30. Thereafter, the body member 4A and the inside member 6 are fixed and retained to the mandrel 30 by setting the air suction paths 36 and 38 to negative pressure so as to adsorb and retain the body member 4A to the outer peripheral adsorption hole 33, and adsorbing and retaining the inside member 6 to the upper surface adsorption hole 35. The adsorption and retention of the body member 4A and the inside member 6 is carried out until the outside member 7 is fusion bonded to the body member 4A and the body member 4A is detached from the mandrel 30.

In the folding step, a body member 4B in which the body side lower end joint portion 4a is temporarily fixed in a folded state is manufactured by bringing a taper surface 41 of a folding member 40 into pressure contact with the corner portion 32a for bending of the mandrel 30 in relation to the boundary portion L of the body member 4A and folding the body side lower end joint portion 4Aa inside, whereby the folded state is maintained, as shown in FIG. 11(b), and inward fitting a fusion bonding head 42 to the folding member 40, heating and pinching the body side lower end joint portion 4a and the inside member 6 between the fusion bonding head 42 and the mandrel 30, and temporarily fusion bonding the body side lower end joint portion 4a and the inside member 6, as shown in FIG. 11(c).

The folding member 40 is comprised of a ring-like member, and a taper surface 41 which is downward expanded in a diameter is formed in a lower end inner peripheral surface of the folding member 40, as shown in FIG. 11. The taper surface 41 is formed into the same shape as the corner portion 32a for bending and a continuously annular shape so that a midstream portion in a width direction faces to the corner portion 32a for bending of the mandrel 30. If an angle θ of incline of the taper surface 41 in relation to the horizontal surface is too great, an angle of folding of the body side lower end joint portion 4Aa is shallow, and if the angle θ of incline is too small, the end portion of the body side lower end joint portion 4Aa is not smoothly guided to the inner peripheral side by the taper surface 41, and a folding defect may be generated. As a result, it is preferable to set the angle θ of incline between 15 and 75 degrees.

The fusion bonding head 42 is structured, as shown in FIG. 11(c), such that the fusion bonding head 42 can be inward fitted to the folding member 40 approximately with no gap, and is structured such that the body side lower end joint portion 4a is reformed into an inward folded state by bringing the fusion bonding head 42 into pressure contact with the inner peripheral portion of the inward folded body side lower end joint portion 4a so as to fusion bond the wrinkles of the body side lower end joint portion 4a, and the body side lower end joint portion 4a can be temporarily fixed in the inward folded state, by fusion bonding the body side lower end joint portion 4a to the inside member 6. The step shown in FIG. 11(c) can be omitted since a certain amount of temporary fixing can be carried out by the folding member 40 in a step shown in FIG. 11(b) in the case that the film material constructing the body member 4A is a weak film material.

In the outside member setting step, the outside member 7 is positioned and fixed at an appropriate position of the body member 4B by using a tubular guide member 43 which can be outward fitted to the body member 4B and forms a guide surface 43a expanded in a diameter toward an upper side in an inner peripheral surface of an upper portion, loading the outside member 7 into the guide member 43 while guiding the outside member 7 by the guide surface 43a in a state in which the guide member 43 is outward fitted to the upper portion of the body member 4B set in the mandrel 30 so as to position and set the outside member 7 on the body member 4B, and temporarily fusion bonding the outside member 7 to the inside member 6 or the body side lower end joint portion 4a in this state, as shown in FIG. 12. In the case that the annular inside member 6A as shown in FIG. 6(a) is used as the inside member 6, the inside member 6A can be adsorbed and retained by the upper surface adsorption hole 35 in the outer peripheral portion and the outside member 7 fed to the appropriate position on the body side lower end joint portion 4a can be adsorbed and retained by the upper surface adsorption hole 35 in the center portion.

In the fusion bonding step, a closed-end container main body 2A obtained by fusion bonding the lower end closing member 5 to the lower end portion of the body member 4C can be obtained by pinching the body side lower end joint portion 4a and the outer peripheral portions of the inside member 6 and the outside member 7 between the upper end surface of the mandrel 30 and a fusion bonding plate 45, fusion bonding the inside member 6 and the outside member 7 to the body side lower end joint portion 4a, and fusion bonding the outer peripheral portion of the inside member 6 and the outer peripheral portion of the outside member 7 in the inner side of the body side lower end joint portion 4a, as shown in FIG. 13. The air suction paths 36 and 38 are returned to the atmospheric pressure, for example, at one second after starting the fusion bonding, and the adsorption of the body members 4A, 4B, and 4C and the lower end closing member 5 is finished. The time from the start of the fusion bonding to the finish of the adsorption can be optionally set, and the adsorption can be finished after the finish of the fusion bonding.

The container main body 2A retained to the mandrel 30 is taken out by feeding the pressure air to each of the air blowout holes 34 after the finish of the fusion bonding, and is transferred to the next spout attaching step.

(Spout Attaching Step)

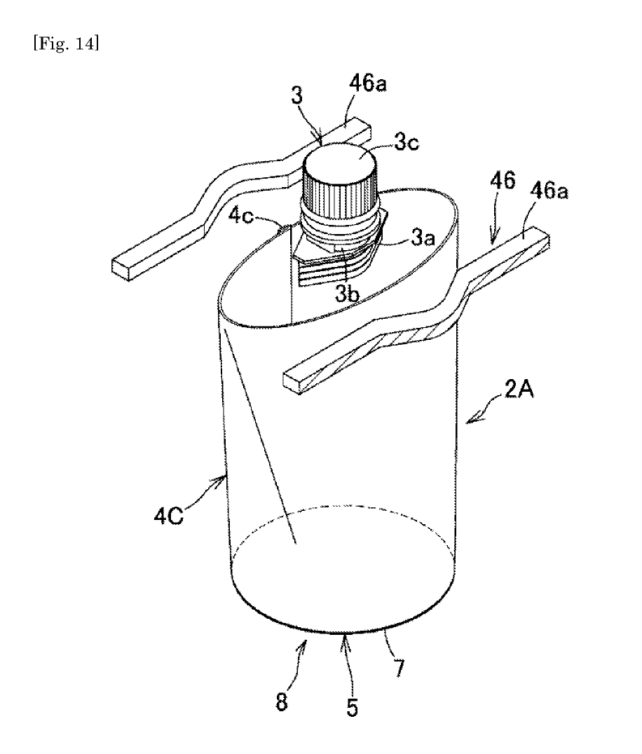

In the spout attaching step, the pouch container 1 can be obtained by using a fusion bonding plate 46 having a pair of fusion bonding portions 46a which is formed into such a shape as to conform to the body side upper end joint portion 4b of the body member 4 in the pouch container 1 in a state in which the main body portion 3a of the spout 3 is arranged inside the upper end portion of the body member 4C of the container main body 2A, forming the body side upper end joint portion 4b closing the upper end opening of the body member 4C while pinching the upper end portion of the body member 4C by the fusion bonding portion 46a, fusion bonding the main body portion 3a of the spout 3 to the upper end portion of the body member 4C while pinching the main body portion 3a of the spout 3 to the center portion in a lateral direction of the body side upper end joint portion 4b of the body member 4C, and attaching the spout 3 to the body member 4C, as shown in FIG. 14.

In the manufacturing method, since the body side lower end joint portion 4Aa is folded inward by the taper surface 41 by pinching the boundary portion L between the main body portion 4d of the body member 4A set to the mandrel 30, and the body side lower end joint portion 4Aa continuously provided in the lower end portion of the main body portion 4d, between the corner portion 32a for bending of the mandrel 30 and the taper surface 41 of the folding member 40, it is possible to easily and finely fold the body side lower end joint portion 4Aa inside. Further, since the body side lower end joint portion 4a is temporarily fixed so that the folded state of the inward folded body side lower end joint portion 4a is maintained, it is possible to stably and efficiently carry out the fusion bonding work between the body side lower end joint portion 4a and the outer peripheral portion of the outside member 7 in the fusion bonding step, and it is possible to easily automate the fusion bonding work of the lower end closing member 5 to one end portion of the body member 4A.

In the case that the pouch container having the body member formed into the oval shape or the polygonal shape is manufactured as the pouch container 1, the pouch container can be manufactured in the same manner as described above by employing the head member 32 of the mandrel 30, the folding member 40 and the taper surface 41, and the fusion bonding head 42 which are formed into the oval shape or the polygonal shape conforming to the lower end shape of the body member.

In the case of manufacturing the pouch container 1A as shown in FIG. 8(a), there are provided a step of folding back outward the upper end portion of the body member 4C of the container main body 2A which is manufactured via the body member forming step and the lower end closing step, and a step of fusion bonding the outer peripheral portion of the upper end closing member 11 having the previously attached spout 12 to the fold-back portion of the body member 4, in place of the spout attaching step. Further, in the case of manufacturing the pouch container 1B shown in FIG. 8(b), there is provided a step of forming the pouring portion as well as fusion bonding the upper end portion of the body member 4C of the container main body 2A which is manufactured via the body member forming step and the lower end closing step, in place of the spout attaching step. Further, when the pouch containers 1C and 1D shown in FIGS. 9(a) and 9(b) are manufactured, the spout 12 is attached to the upper end closing member 21 by manufacturing the container main body 2 in which the upper end closing member 21 is fusion bonded to the body member 4 in place of the lower end closing member 5 in the same procedures as the body member forming step and the lower end closing step, forming the through hole 21a in the center of the upper end closing member 21 in the container main body 2, and inserting the opening portion 12a into the through hole 21a from the lower side. Thereafter, the lower end closing member 26 is fusion bonded to the lower surface of the fold-back portion after folding back the lower end portion of the body member 4 outside in the case of manufacturing the pouch container 1C, and the bottom member 27 is fusion bonded to the lower end portion of the body member 4 by loading the bottom member 27 into the lower end portion of the body member 4 in the case of manufacturing the pouch container 1D.

### Second Embodiment

Next, a description will be given of a pouch container in which a closing member is comprised of one film material.

As shown in FIGS. 15 to 18, a pouch container 51 is comprised of a container main body 54 which has a tubular body member 52, and a lower end closing member 53 (corresponding to an outside member) closing a lower end opening of the body member 52, and is comprised of a soft film, and a spout 55 which is fusion bonded and fixed to an upper end portion of the body member 52, and is structured such that a waste material can be volume-reduced by folding or collapsing by a hand the body member 52 and the lower end closing member 53 after the use of the content.

The film material constructing the body member 52 is comprised of a soft film having a single layer structure or a multilayer structure which can be volume-reduced by a hand. It is possible to preferably employ, for example, a laminate film having at least three-layer structure in which a sealant layer made of a thermoplastic synthetic resin material such as a polyolefin resin and capable of fusion bonding to each other by a heat seal, an ultrasonic seal, or the like is provided in both surfaces of the film material, and a base material layer or a plurality of base material layers are provided between both the sealant layers, the base material layer being made of a functional material having a function such as a gas barrier performance and a light blocking effect in correspondence to the content accommodated in the pouch container 51.

The film material constructing the lower end closing member 53 is comprised of a soft film having a single layer structure or a multilayer structure. For example, it is possible to preferably employ a laminate film having at least two-layer structure, in which a sealant layer made of the thermoplastic synthetic resin material such as the polyolefin resin and capable of fusion bonding to each other by the heat seal, the ultrasonic seal, or the like is provided in one outer surface of the film material, and a base material layer or a plurality of base material layers are provided in the other outer surface, the base material layer being made of the functional material having a function such as an abrasion resistance, the gas barrier performance, and the light blocking effect. As the film material constructing the lower end closing member 53, it is possible to employ a film material in which one base material layer or a plurality of base material layers made of the functional material having a function such as the gas barrier performance and the light blocking effect is provided as the base material layer, and the sealant layer is formed in both surfaces of the base material layer, in the same manner as the film material constructing the body member 52. As the film material constructing the body member 52 and the lower end closing member 53, it is possible to employ any optional structure as long as the film material can be volume-reduced by a hand and the bonded surface between the film materials or between the film material and the spout 55 can be fusion bonded to each other. Further, the body member 52 can be comprised of the film material having the same structure as the body member 4 according to the first embodiment, and the lower end closing member 53 can be comprised of the film material having the same structure as the outside member 7 according to the first embodiment, respectively.

The body member 52 is formed into a shape obtained by crushing an upper end portion of the body member formed into a cylindrical shape and made of the film material flat, is formed into an approximately circular shape in its lower end portion, and is formed into a flat transverse sectional shape which is narrowed a back and forth width from the lower end portion toward an upper side, a body side upper end joint portion 52a obtained by fusion bonding the film materials in the front surface side and the rear surface side is formed in an upper end portion thereof, and a spout 55 is fusion bonded and retained between the film material in the front surface side and the film material in the rear surface side in a midstream portion in a length direction (a lateral direction) of the body side upper end joint portion 52a. The body member 52 is formed into a tubular shape by rolling up one film material into a cylindrical shape, superposing both end portions, and bonding both end portions by a heat seal, an ultrasonic seal, or the like, and a body side lateral part joint portion 52b is formed in an outer side of the center portion in the lateral direction of a rear surface of the body member 52 over a whole length in a height direction, the body side lateral part joint portion 52b being butt seamed and having the film material bonded thereto. As the film material constructing the body member 52, it is possible to employ a tubular inflation film which is formed by an inflation molding, and a body member 52 having no body side lateral part joint portion 52b can be manufactured in this case. Further, the body side lateral part joint portion 52b can be bonded by the envelope bonding. In the case that the body side lateral part joint portion 52b is formed by the butt seaming or the envelope bonding, it is possible to obtain the same operations and effects as those of the case that the body side lateral part joint portion 4c is formed by the butt seaming or the envelope bonding according to the first embodiment. Further, the body side lateral part joint portion 52b can be formed at an optional position in the peripheral direction of the body member 52.

The lower end closing member 53 is comprised of a circular film material which conforms to the lower end portion of the body member 52. Describing a lower end closing structure 56 of the body member 52 using the lower end closing member 53, a collar-like body side lower end joint portion 52c protruding inward and formed into an endless annular shape is provided in a lower end portion of the body member 52 by bending inside. An outer peripheral joint portion 53a is formed in an outer peripheral portion of the lower end closing member 53, and the lower end closing member 53 is attached to a lower end portion of the body member 52 so as to close a lower end opening portion of the body member 52 in a liquid tight manner by superposing the outer peripheral joint portion 53a on the lower side of the body side lower end joint portion 52c and bonding both the joint portions by the heat seal, the ultrasonic seal, or the like.

The container main body 54 is structured such that a whole of the lower surface of the lower end closing member 53 can be vertically self-standing by being installed to an installation surface. Further, the lower end portion of the container main body 54 is provided with an endless annular and thick lower end joint portion 54a obtained by fusion bonding the body side lower end joint portion 52c and the outer peripheral joint portion 53a, an outer peripheral portion of a bottom surface of the container main body 54 is reinforced by the lower end joint portion 54a, and a self-standing stability of the container main body 54 is enhanced. The lower end joint portion 54a is formed by pinching the body side lower end joint portion 52c and the outer peripheral joint portion 53a between a pair of heating molds, and thermally fusion bonding sealant layers of the both.

A thickness of the sealant layer of the soft film constructing the body member 52 and the lower end closing member 53 is set between 10 and 200 μm so that the fusion bonding between the body side lower end joint portion 52c and the outer peripheral joint portion 53a can be securely achieved with no seal defect. Further, in the case that the width of the lower end joint portion 54a is less than 1 mm, a bonding strength of the lower end joint portion 54a can not be sufficiently secured, and if the width goes beyond 10 mm, a workability when the body side lower end joint portion 52c is formed by bending the lower end portion of the body member 52 inside is lowered. As a result, the width is set between 1 and 10 mm.

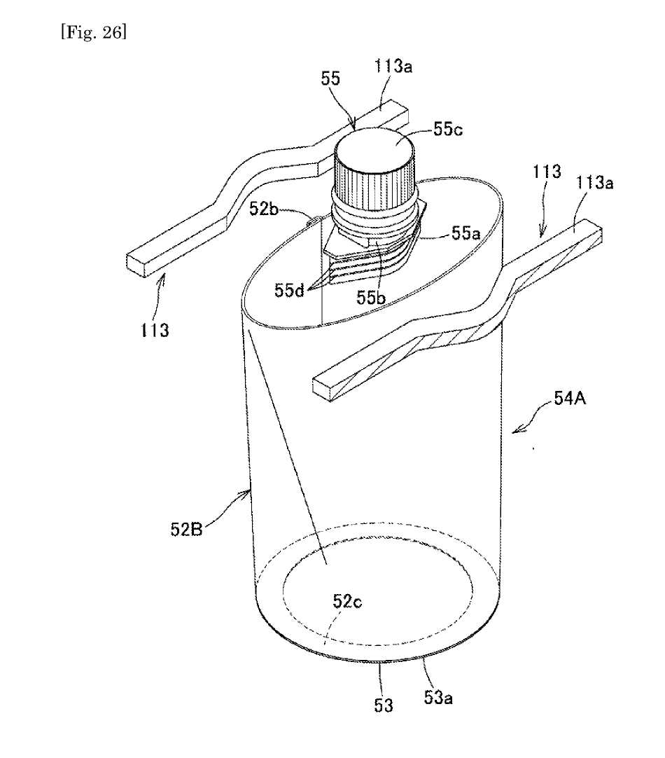

The spout 55 is comprised of a boat-shaped spout provided with a boat-shaped main body portion 55a which is formed to be the widest in its center portion and be narrower toward both end portion sides and has a height in a plan view, a tubular opening portion 55b which is provided in a rising manner in the main body portion 55a, and a lid body 55c which is threadably engaged with the opening portion 55b in a detachable manner, as shown in FIGS. 15, 16, and 26. When the spout 55 is attached to the container main body 54, the lower end closing member 53 is attached to a body member 52B of a container main body 54A before the attachment of the spout 55, the main body portion 55a of the spout 55 is arranged in an inner side of an upper end portion of the body member 52B, and the upper end portion of the body member 52B is brought into pressure contact with the main body portion 55a so as to be fusion bonded, and is attached to the container main body 54A in a liquid tight manner when the body side upper end joint portion 52a is formed by fusion bonding the upper end portion of the body member 52B by the heat seal, the ultrasonic seal, or the like, as shown in FIG. 26. As a raw material of the spout 55, it is possible to employ an optional thermoplastic synthetic resin material as long as the synthetic resin material can be fusion bonded to the body member 52B and has a strength rigidity serving as the spout 55, for example, a thermoplastic synthetic resin such as a high density polyethylene can be employed. It is possible to employ a spout having a main body portion including a tubular side wall portion which is inward fitted to an upper end opening portion of the body member 52B approximately with no gap or a side wall portion which is fitted its lower end portion to an upper end opening portion of the body member 52B approximately with no gap and is diameter-reduced toward an upper side, and an opening portion which is provided in a rising manner in the main body portion, in place of the spout 55. In this case, a columnar pouch container having a circular columnar shape or the like can be manufactured by inward fitting the main body portion of the spout to the upper portion of the body member 52B and fusion bonding the upper portion of the body member 52B and the side wall portion of the spout.

One annular protruding portion or a plurality of annular protruding portions 55d (refer to FIG. 26) are formed in a midstream portion in a height direction of an outer peripheral surface of the main body portion 55a before the fusion bonding to the body member 52, and the annular protruding portion 55d is fusion bonded to the body member 52 by being molten when the body member 52 is fusion bonded to the outer peripheral surface of the main body portion 55a, whereby a sealing performance between the outer peripheral surface of the main body portion 55a and the body member 52 can be well secured. It is possible to employ the other spout than the boat-shaped spout having a main body portion which is formed into a rhombic shape or a cruciform shape in a plan view as long as the upper end portion of the body member 52 is brought into pressure contact with the main body portion 55a from a side direction so as to be fusion bonded, in a state in which the main body portion 55a of the spout 55 is arranged in the upper end opening portion of the body member 52.

In the pouch container 51, since the body member 52 and the lower end closing member 53 are comprised of the film material, the pouch container 51 can be volume-reduced by crushing the body member 52 and the lower end closing member 53 flat after the use of the content. Further, since the inward protruding endless annular body side lower end joint portion 52c is provided in the lower end portion of the body member 52, and the lower end closing member 53 is attached so as to close the one end opening of the body member 52 by fusion bonding the outer peripheral portion of the lower end closing member 53 to the body side lower end joint portion 52c, it is possible to stably install the container main body 54 by installing a whole surface of the lower end closing member 53 to the installation surface when the lower end closing member 53 is provided in the lower end portion of the body member 52, and it is possible to improve the self-standing stability of the pouch container 51. Further, since the lower end joint portion 54a obtained by fusion bonding the outer peripheral portion of the lower end closing member 53 to the body side lower end joint portion 52c does not protrude outward from the container main body 54, it is possible to prevent the design property of the pouch container 51 from being lowered by the lower end joint portion 54a.

Next, a description will be given of the other embodiment in which the structure of the pouch container 51 is partly changed. A detailed description of the same members as the pouch container 51 will be omitted by attaching the same reference numerals.

The lower end portion of the body member 52 is formed into the circular shape, however, can be formed into an oval shape, a flat circular shape, a streamline, or a polygonal shape such as a quadrangular shape and a hexagonal shape. Further, the body member 52 is formed into the flat cross sectional shape which is narrowed its back and forth width from the lower end portion toward the upper side, however, can be structured such that only the upper end portion of the body member 52 is diameter-reduced gently by forming a portion from the lower end portion to the upper end portion of the body member 52 into a tubular shape having the same cross sectional shape as the lower end portion of the body member 52, or forming a portion from the lower end portion to the upper portion of the body member 52 into a tubular shape having the same cross sectional shape as the lower end portion of the body member 52. Further, it is possible to structure the pouch container 51 such as to be easily held and it is possible to enhance the self-standing stability, the functionality, and the design property of the pouch container 51, by constructing the body member 52 into a frustum of circular cone or a frustum of pyramid or forming a constriction portion in the midstream portion of the body member 52. Further, in order to easily fold the body member 52, it is possible to form a plurality of fold lines extending in a vertical direction in the midstream portion in the peripheral direction of the body member 52, or form a gusset. Further, the body member 52 is constructed into the tubular shape by rolling up one film material into the tubular shape and fusion bonding both the end portions, however, it is possible to employ a body member 52 obtained by superposing two film materials and fusion bonding side portions thereof, or bonding three or more film materials.

In the case that the lower end closing member 53 is formed into the shape which conforms to the lower end portion of the body member 52, and the lower end portion of the body member 52 is formed into the oval shape, the flat circular shape, the streamline, or the polygonal shape such as the quadrangular shape and the hexagonal shape, the lower end closing member 53 is formed into the shape conforming thereto. Further, it is preferable to form the fold line in the lower end closing member 53 so that the lower end closing member 53 is easily folded when the body member 52 is folded.

Further, with regard to the lower end closing structure 56 of the lower end closing member 53, one seal portion 54b or a plurality of seal portions 54b can be formed in a midstream portion in a width direction of the lower end joint portion 54a, the seal portion 54b being comprised of an annular protruding portion over a whole periphery of the lower end joint portion 54a, such as a lower end closing structure 56A shown in FIG. 19(a). Further, the lower end opening of the body member 52 can be closed in a liquid tight manner by a lower end closing member 53B by setting the lower end closing member 53B (corresponding to the inside member) which is arranged closer to an inner portion side of the container main body 54 than the body side lower end joint portion 52c and is comprised of a soft film, and fusion bonding an outer peripheral joint portion 53Ba in an outer peripheral portion of the lower end closing member 53B to an inner surface side of the body side lower end joint portion 52c, like a lower end closing structure 56B shown in FIG. 19(b). As the lower end closing member 53B, it is possible to employ a discoid shape member having a size which conforms to the lower end portion of the body member 52. Further, the lower end closing member 53B can be comprised of a single layer film, for example, a polyethylene (PE) which has compatibility with the sealant layer in the lower end closing member 53 and the body side lower end joint portion 52c. Further, the lower end closing member 53B can be comprised of the same film material as the inside member 6 in the first embodiment.

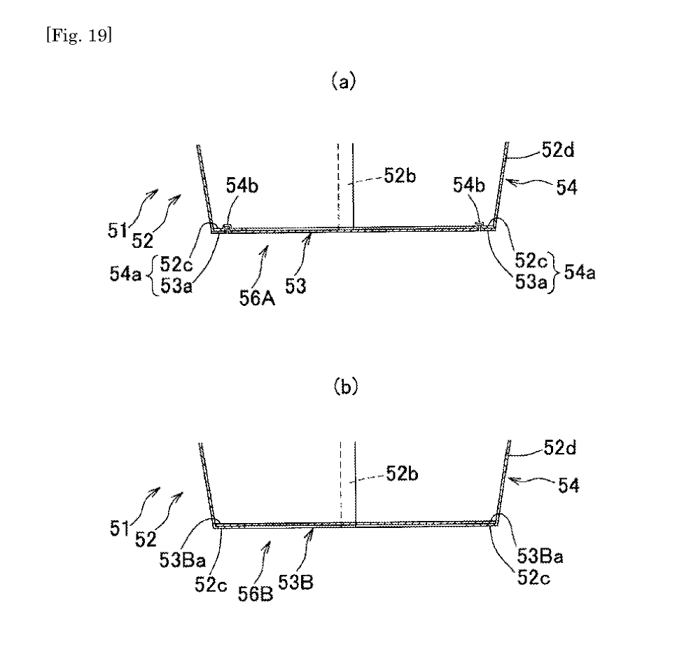

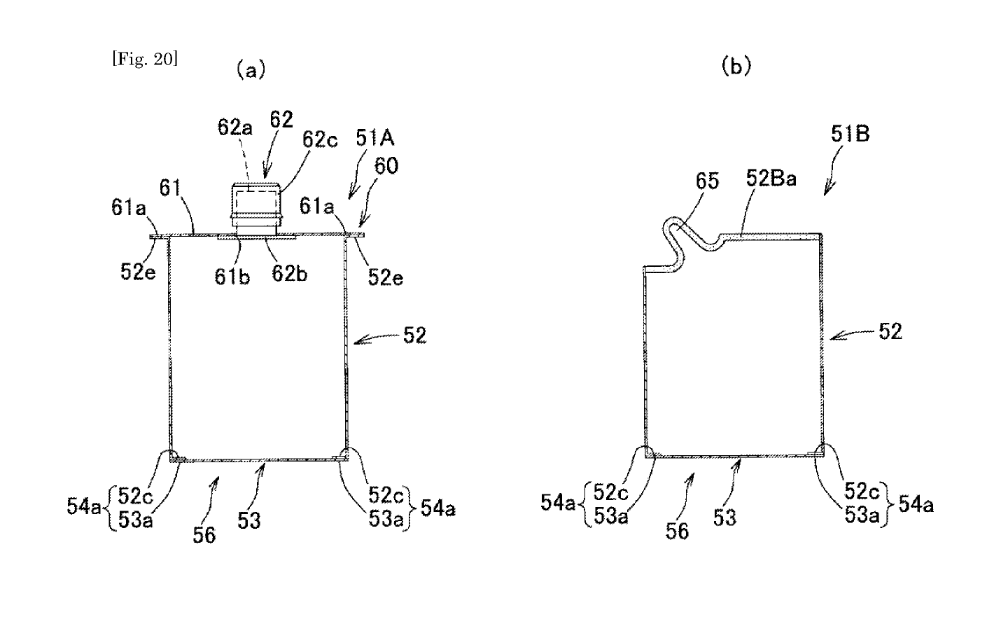

Further, the other spout than the boat-shaped spout can be employed as the spout 55, and the attaching structure thereof can employ an attaching structure having an appropriate structure in correspondence to the shape of the spout 55. For example, the lower end portion of the body member 52 can be closed by the same lower end closing structure 56 as mentioned above, and the upper end portion of the body member 52 can be closed by a closing structure 60 having the following structure, like a pouch container 51A shown in FIG. 20(a). In other words, the upper end opening can be closed by an upper end closing member 61 by forming an annular collar portion 52e extending outward in an upper end portion of the body member 52, setting the upper end closing member 61 which is comprised of the same soft film as the lower end closing member 53, and fusion bonding an outer peripheral joint portion 61a of the upper end closing member 61 to an upper surface of the collar portion 52e. Further, a spout 62 can be attached by employing the spout 62 having a cylindrical opening portion 62a, an annular flange portion 62b which protrudes outward from the opening portion 62a, and a lid member 62c which is attached to the opening portion 62a, as the spout, inserting the opening portion 62a to a through hole 61b which is formed in the center portion of the upper end closing member 61 from a lower side, and fusion bonding the flange portion 62b to a lower surface of the upper end closing member 61.

Further, the present invention can be applied to a container which does not have the spout 55. For example, like a pouch container 51B shown in FIG. 20(b), a body side upper end joint portion 52Ba can be formed by closing the lower end portion of the body member 52 by the same lower end closing structure 56 as mentioned above, integrally forming a pouring portion 65 in the upper end portion of the body member 52, and superposing upper edges of the body member 52 so as to fusion bond, and the content can be taken out by cutting a leading end portion of the pouring portion 65.

Further, like pouch containers 51C and 51D in FIGS. 21(a) and 21(b), the upper end portion of the body member 52 can be closed by an upper end closing structure 70 having the same structure as the lower end closing structure 56. Specifically, like the upper end closing structure 70 shown in FIGS. 21(a) and 21(b), a collar-like body side upper end joint portion 52f protruding inward and formed into an endless annular shape is formed in the upper end portion of the body member 52 by bending inside, the upper end opening portion of the body member 52 is closed in a liquid tight manner by setting an upper end closing member 71 which is comprised of the same soft film as the lower end closing member 53, superposing an outer peripheral joint portion 71a of the upper end closing member 71 on an upper side of the body side upper end joint portion 52f, and bonding both the joint portions 52f and 71a by the heat seal, the ultrasonic seal, or the like, and the spout 62 can be attached by inserting the opening portion 62a of the spout 62 into a through hole 71b which is formed in the center portion of the upper end closing member 71 from a lower side, in the same manner as the pouch container 51A in FIG. 20(a). Further, the lower end opening portion of the pouch container 51 can be structured, like a pouch container 51C in FIG. 21(a), such that an annular collar portion 75 extending outward is formed in a lower end portion of the body member 52, and a lower end closing member 76 comprised of the same soft film as the lower end closing member 53 is provided by fusion bonding an outer peripheral portion to a lower surface of the annular collar portion 75, or can be structured, like a pouch container 51D in FIG. 21(b), such that a bottom member 77 having a well-known structure is fusion bonded to an inner side of the lower end portion of the body member 52.

The pouch container 51 can be manufactured by partly changing the manufacturing method of the pouch container 1 according to the first embodiment as follows.

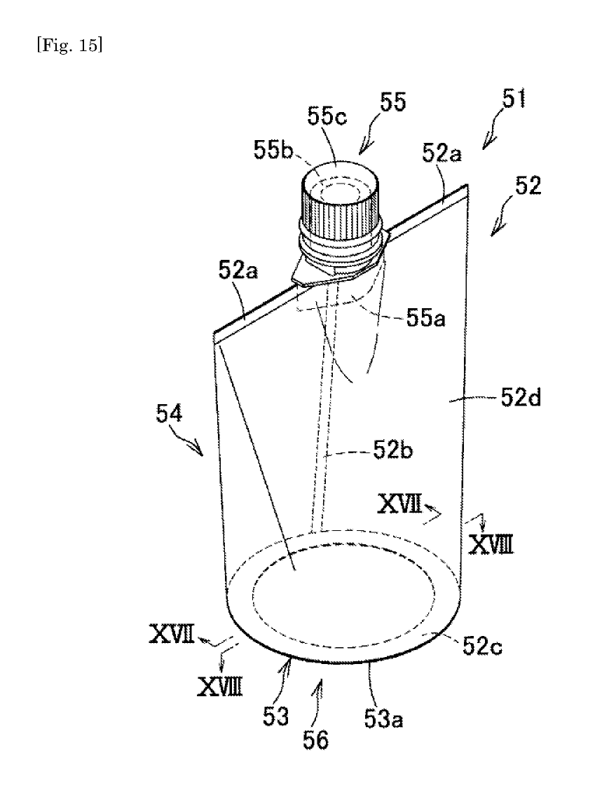

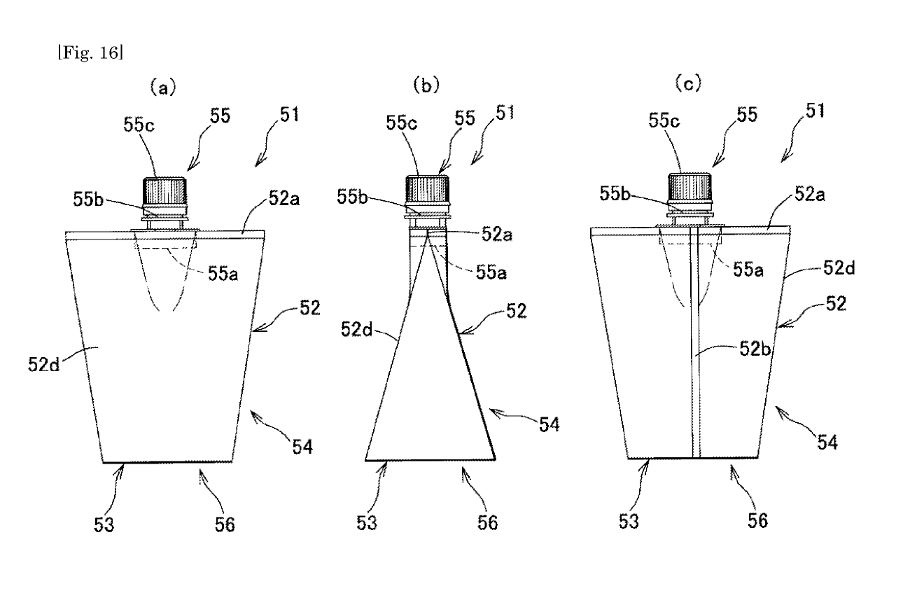

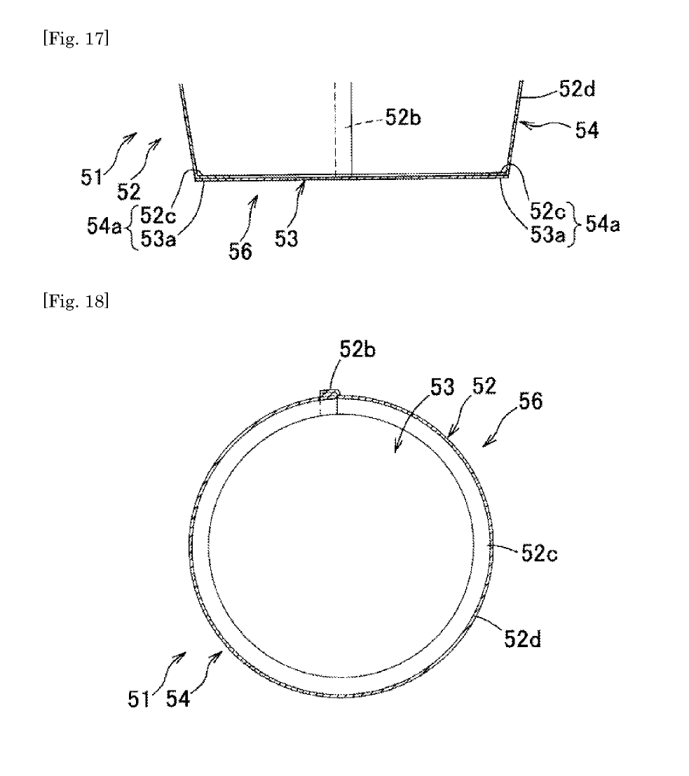

In other words, in the case of manufacturing the pouch container 51 provided with the lower end closing member 53 (provided only with the outside member) and shown in FIGS. 17 and 18, the cylindrical body member 4A comprised of the film material is formed in the body member forming step in the same manner as the first embodiment, however, the lower end closing member 53 is formed by fusion bonding only the outside member 7 to the lower end portion of the body member 4A in the lower end closing step, and the spout 55 is thereafter attached to the upper end portion of the body member 4A in the same manner as the first embodiment in the spout attaching step.

As a result, in the lower end closing step, the body member 4A is set to the mandrel 30 in an outward fitting manner as shown in FIG. 11(a) first of all in the setting step, however, the inside member 6 is not set to the upper surface of the mandrel 30. Thereafter, the lower end closing member 53 is formed in the lower end portion of the body member 4 by folding the tubular body side lower end joint portion 4Aa of the body member 4A inside so as to temporarily fix in the folding step as shown in FIG. 11(b), next setting the outside member 7 at an appropriate position on the folded body side lower end joint portion 4a in the outside member setting step as shown in FIG. 12, and next fusion bonding the outer peripheral portion of the outside member 7 to the body side lower end joint portion 4a in the fusion bonding step as shown in FIG. 13.

Further, in the case of manufacturing the pouch container 51 provided with the lower end closing member 53B (provided only with the inside member) and shown in FIG. 19(b), the cylindrical body member 4A comprised of the film material is formed in the body member forming step in the same manner as the first embodiment, however, the lower end closing member 53B is formed by fusion bonding only the inside member 6 to the lower end portion of the body member 4A in the lower end closing step, and the spout 55 is thereafter attached to the upper end portion of the body member 4A in the spout attaching step in the same manner as the first embodiment.

As a result, in the lower end closing step, the lower end closing member 53B is formed in the lower end portion of the body member 4 by setting the body member 4A to the mandrel 30 in an outward fitting manner, and setting the inside member 6 to the upper surface of the mandrel 30, first of all in the setting step as shown in FIG. 11(a), folding the tubular body side lower end joint portion 4Aa of the body member 4A inside so as to temporarily fix thereafter in the folding step, as shown in FIG. 11(b), omitting the outside member setting step, and fusion bonding the outer peripheral portion of the inside member 6 to the body side lower end joint portion 4a in the next fusion bonding step as shown in FIG. 13.

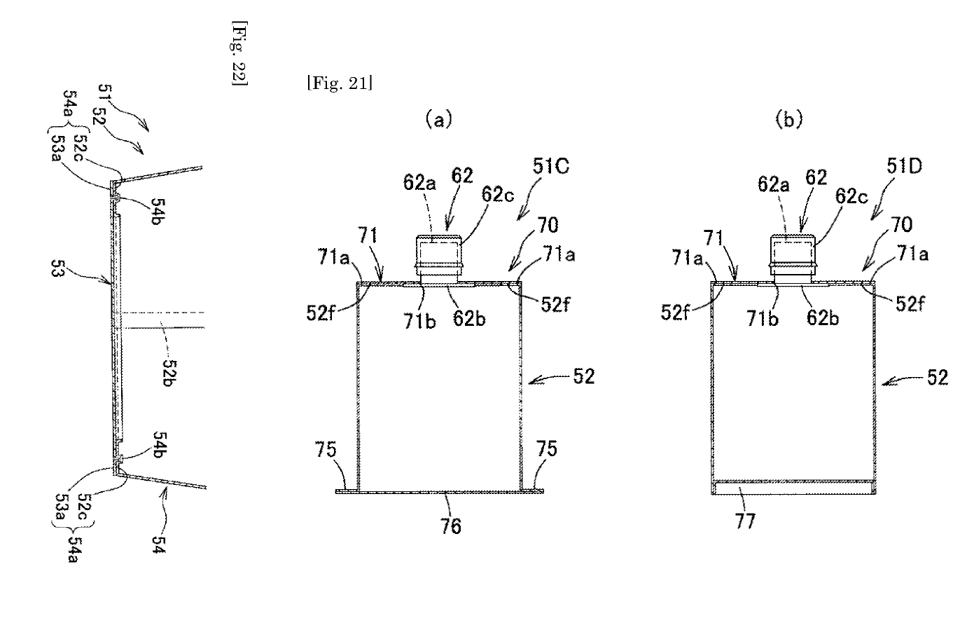

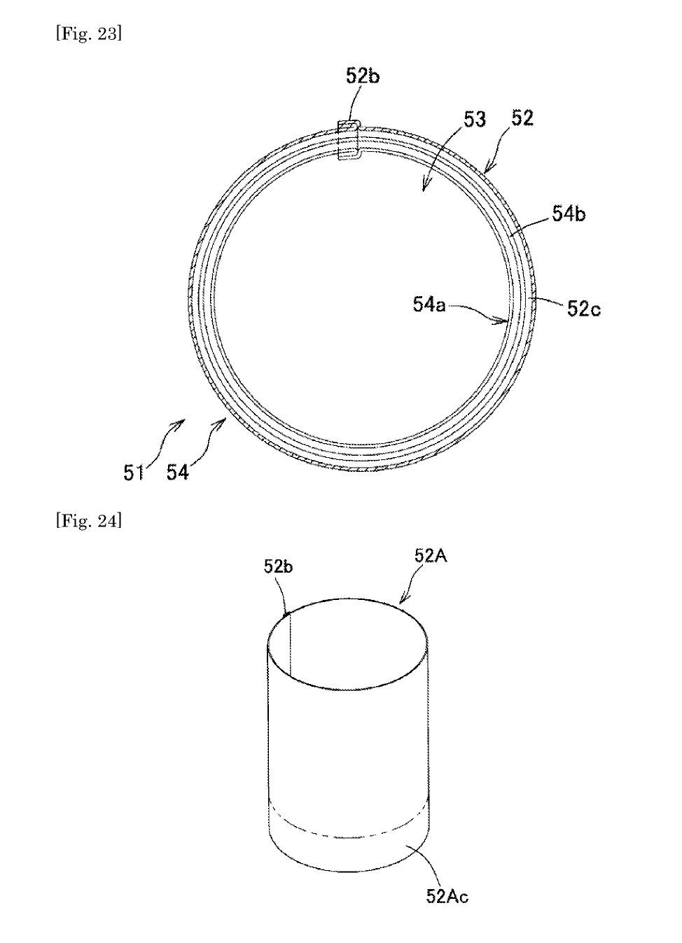

Next, a description will be given of the other manufacturing method of the pouch container 51 which is provided with a lower end closing structure shown in FIGS. 22 and 23. Since the pouch container 51 has the same structure as the pouch container 51 shown in FIGS. 15, 16, and 19 except a structure in which an inner peripheral end portion of the body side lower end joint portion 52a protrudes upward within the container main body 54, a description thereof will be omitted by attaching the same reference numerals to the same members.

A manufacturing method of the pouch container 51 is provided with a body portion forming step, a lower end closing step, and a spout attaching step. A cylindrical body member 52A is manufactured by using one body portion film in the body portion forming step, a closed-end tubular member comprised of a lower end closing member 53 and a body member 52A is manufactured by attaching the lower end closing member 53 to a lower end of the body member 52A in the lower end closing step, and the pouch container 51 is obtained by attaching the spout 55 to the container main body 54 in the spout attaching step. In the case that the spout 55 is not provided, the spout attaching step can be omitted.

### <Body Portion Forming Step>

In the body portion forming step, the cylindrical body member 52A is manufactured by rolling up one body portion film into a cylindrical shape, superposing both end portions, bonding the overlapped portions by the heat seal, the ultrasonic seal, or the like, and forming the body side lateral part joint portion 52b, as shown in FIG. 24.

### <Lower End Closing Step>

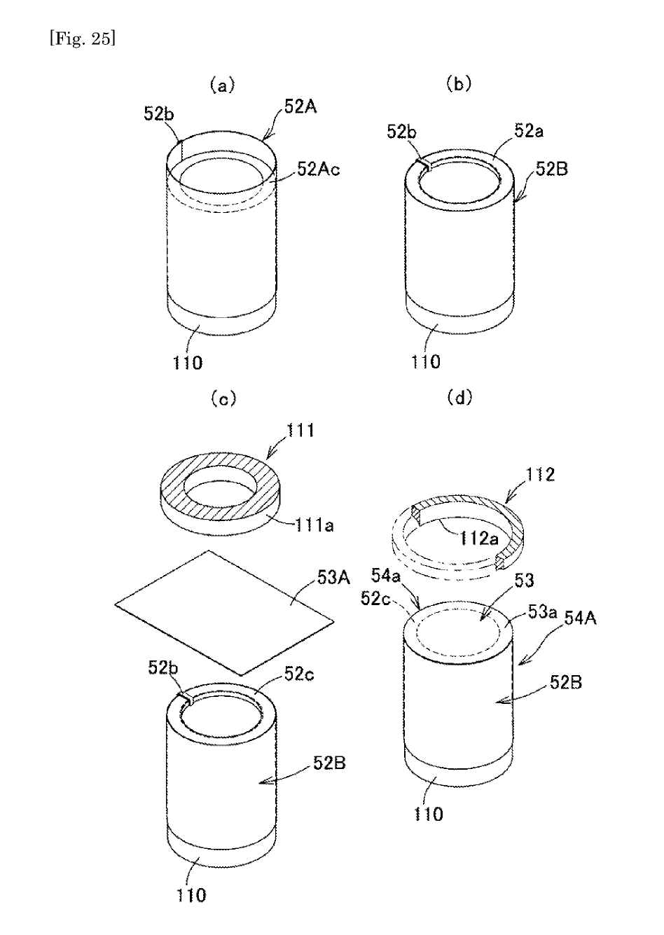

The lower end closing step is provided with a loading step, a fold-back step, a fusion bonding step, and a trimming step as shown in FIG. 25. The closed-end tubular container main body 54A is obtained by using a tubular attaching jig 110 to which the body member 52A can be outward fitted approximately with no gap, loading the body member 52A to the attaching jig 110 in an outward fitting manner in the loading step while transferring the attaching jig 110, folding back the lower portion 52Ac of the body member 52A inside so as to form the body side lower end joint portion 52c in the fold-back step, fusion bonding the bottom portion film 53A to the body side lower end joint portion 52c of the body member 52B in the fusion bonding step, and trimming an unnecessary portion of the bottom portion film 53A outside the lower end joint portion 54a in the trimming step. A description will be given below specifically.

First of all, the cylindrical body member 52A is loaded to the tubular attaching jig 110 in an outward fitting manner in the loading step as shown in FIG. 25(a). A thickness of the attaching jig 110 is set to be approximately equal to or slightly larger than a width of the lower end joint portion 54a. Further, a height of the attaching jig 110 is set to a height at which the lower portion 52Ac of the body member 52A constructing the lower end joint portion 54a protrudes upward from the attaching jig 110 in a state in which the body member 52A is loaded to the attaching jig 110 in an outward fitting manner. The attaching jig 110 is formed into a transverse sectional shape which conforms to a transverse sectional shape of the body member 52A.

Next, in the fold-back step, the body member 52B forming the body side lower end joint portion 52c which is comprised of the fold-back portion and is formed into the endless annular shape is manufactured in the upper side of the attaching jig 110, by folding back the lower portion 52Ac of the body member 52A protruding upward from the attaching jig 110 inside so as to be reversed inside and outside around an upper end edge of the attaching jig 110, as shown in FIG. 25(b). As mentioned above, it is possible to easily and efficiently form the body member 52B having the endless annular body side lower end joint portion 52c by folding back the lower end portion of the body member 52A. In the case that the body member 52A is comprised of a plurality of body portion films, it is preferable to structure the lower portion 52Ac such that the diameter thereof is reduced toward the lower side. According to the structure, the fold-back work of the lower portion 52Ac is easily carried out.

Next, in the fusion bonding step, the bottom portion film 53A is fusion bonded to the body side lower end joint portion 52c by feeding the bottom portion film 53A to the upper side of the body side lower end joint portion 52c of the body member 52B, employing a heating plate 111 having an annular heating portion 111a which is slightly wider than the upper surface of the attaching jig 110, and pinching the body side lower end joint portion 52c and the bottom portion film 53A between the heating portion 111a of the heating plate 111 and the attaching jig 110, as shown in FIG. 25(c). The bottom portion film 53A can be supplied to the upper side of the body side lower end joint portion 122c one by one, however, it is preferable to sequentially supply an elongated band-like bottom portion film to the upper side of the body side lower end joint portion 52c. Further, the seal portion 54b can be formed by employing the attaching jig 110 and the heating plate 111 which are structured such that an annular fitting groove or fitting protruding portion is formed in the upper surface of the attaching jig 110 and a fitting protruding portion or a fitting groove fitted in a concavo-convex manner to the fitting groove or the fitting protruding portion of the attaching jig 110 is formed in a heating surface of the heating plate 111, and pinching in a heating manner the body side lower end joint portion 52c and the bottom portion film 53A between the upper surface of the attaching jig 110 and the heating plate 111.

Next, in the trimming step, the closed-end cylindrical container main body 54A having the lower end joint portion 54a can be obtained by cutting the unnecessary portion of the bottom portion film 54A protruding outward from the attaching jig 110 by a blade portion 112a of a trimming blade 112 as shown in FIG. 25(d), the lower end joint portion Ma being obtained by fusion bonding the body side lower end joint portion 52c of the body member 52B and the outer peripheral joint portion 53a in the outer peripheral portion of the lower end closing member 53 to the lower end portion.

In the fusion bonding step, it is preferable to supply a bottom portion film formed into the shape of the lower end closing member 53 as the bottom portion film 53A to the upper side of the body side lower end joint portion 52c one by one. In this case, the trimming step can be omitted.

### <Spout Attaching Step>

Next, in the spout attaching step, the body side upper end joint portion 52a closing the upper end opening of the body member 52B is formed by using a heating plate 113 having a pair of heating portions 113a which is formed into a shape conforming to the body side upper end joint portion 52a of the body member 52B in the pouch container 51 and pinching the upper end portion of the body member 52B by the heating portions 113a in a state in which the main body portion 55a of the spout 55 is arranged inside the upper end portion of the body member 52B of the container main body 54A, and the pouch container 51 is obtained by pinching the main body portion 55a of the spout 55 to the center portion in the lateral direction of the body side upper end joint portion 52a of the body member 52B, fusion bonding the main body portion 55a of the spout 55 to the upper end portion of the body member 52B, and attaching the spout 55 to the body member 52B, as shown in FIG. 26.

In the manufacturing method of the pouch container 51, since the body side lower end joint portion 52c comprised of the endless annular fold-back portion is formed in the body member 52A in the upper side of the attaching jig 110 by loading the body member 52A to the attaching jig 110 in an outward fitting manner, and folding back the tubular lower portion 52Ac of the body member 52A protruding upward from the attaching jig 110 so as to be reversed inside and outside around the upper end edge of the attaching jig 110, it is possible to efficiently form the body side lower end joint portion 52c in the lower end portion of the body member 52. Further, since the fold-back work of the body member 52A can be comparatively easily automated, and the loading step, the fusion bonding step, and the trimming step can be comparatively easily automated, it is possible to automate a whole of the lower end closing step. Further, since the width of the body side lower end joint portion 52c of the body member 52 is the size in correspondence to the width of the upper end surface of the attaching jig 110, it is possible to sufficiently secure a width of the lower end joint portion 54a obtained by fusion bonding the body side lower end joint portion 52c of the body member 52 and the outer peripheral joint portion 53a in the outer peripheral portion of the lower end closing member 53 over a whole periphery, and it is possible to prevent the bonding strength and the liquid tightness from being lowered due to partial reduction of a fusion bonding area. Further, since the lower end joint portion 54a is arranged inside the container main body 54 and does not protrude outward, it is possible to improve the design property of the pouch container 51.

Next, a description will be given of a pouch container 121 obtained by partly changing the structure of the pouch container, and the other embodiment of the manufacturing method. A detailed description of the same members as those of the pouch container 51 shown in FIGS. 22 and 23 will be omitted by attaching the same reference numerals.

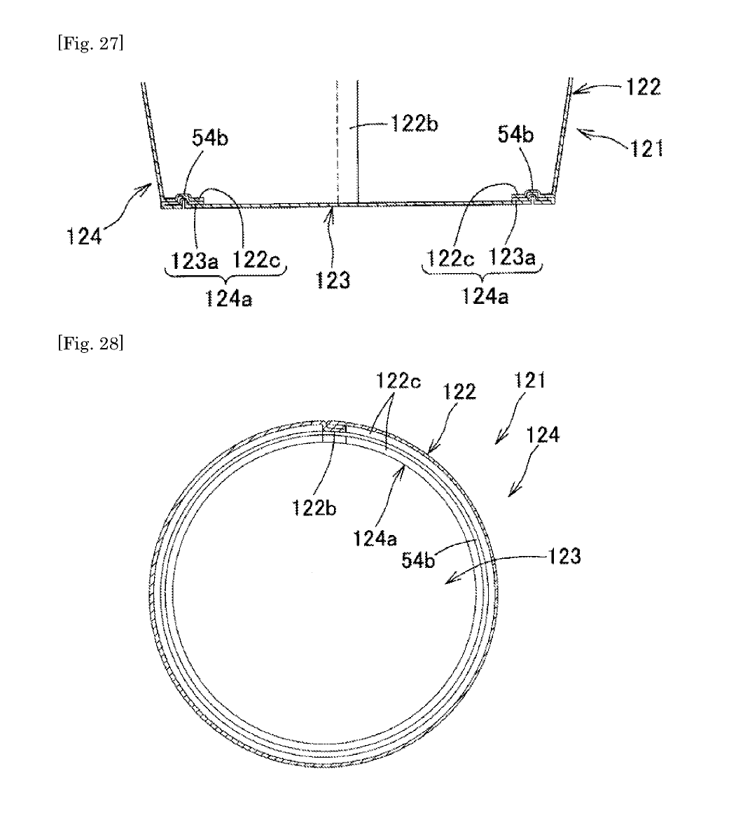

As shown in FIGS. 27 and 28, the pouch container 121 is obtained by using a body member 122 in which the body side lateral part joint portion 52b is arranged inside, in place of the body member 52 of the pouch container 51 shown in FIGS. 22 and 23, using a lower end closing member 123 in which an outer peripheral joint portion 123a is formed by folding back an outer peripheral portion inside, in place of the lower end closing member 53 of the pouch container 51, and forming a lower end joint portion 124a protruding into a container main body 124 in a lower end outer peripheral portion of the container main body 124 by bonding the outer peripheral joint portion 123a to the lower surface of the body side lower end joint portion 52c, in place of the lower end joint portion 54a. The others are structured such as to be the same as the pouch container 51 shown in FIGS. 22 and 23.

In the pouch container 121, in the same manner as the pouch container 51, since the pouch container 121 can be volume-reduced by crushing the body member 122 and the lower end closing member 123 flat, a whole surface of the lower end closing member 123 can be stably installed to the installation surface, and the pouch container 121 can be stably installed by the lower end joint portion 124a, it is possible to improve the self-standing stability of the pouch container 121 while employing a thin material as the film material which constructs the body member 122 of the container main body 124 and the lower end closing member 123. Further, since the lower end joint portion 124a is arranged inside the container main body 124, there can be obtained the operations and effects of, for example, prevention of the design property of the pouch container 121 from being lowered by the lower end joint portion 124a.

Next, a description will be given of a manufacturing method of the pouch container 121.

The manufacturing method of the pouch container 121 is provided with a body portion forming step, a lower end closing step, a reversing step, and a spout attaching step. In the body portion forming step, the cylindrical body member 52A is manufactured by using one body portion film in the same manner as the manufacturing method of the pouch container 51. In the lower end closing step, a tubular member 124A comprised of a lower end closing member 123 and a body member 122 and formed into a closed-end cylindrical shape is manufactured by attaching the lower end closing member 123 to the lower end of the body member 52A, as shown in FIGS. 24 and 25, a closed-end cylindrical container main body 124B is manufactured by reversing inside and outside the tubular member 124A in the reversing step, and the spout 55 is attached to the container main body 124B in the same manner as the manufacturing method of the pouch container 51 in the spout attaching step, thereby obtaining the pouch container 121. In the case that the spout 55 is not provided, the spout attaching step is omitted.

### <Body Portion Forming Step>

In the body portion forming step, the cylindrical body member 52A is manufactured by rolling up one body portion film into a cylindrical shape, superposing both end portions, and bonding the overlapped portions by the heat seal, the ultrasonic seal, or the like, as shown in FIG. 24 in the same manner as the pouch container 51.

### <Lower End Closing Step>

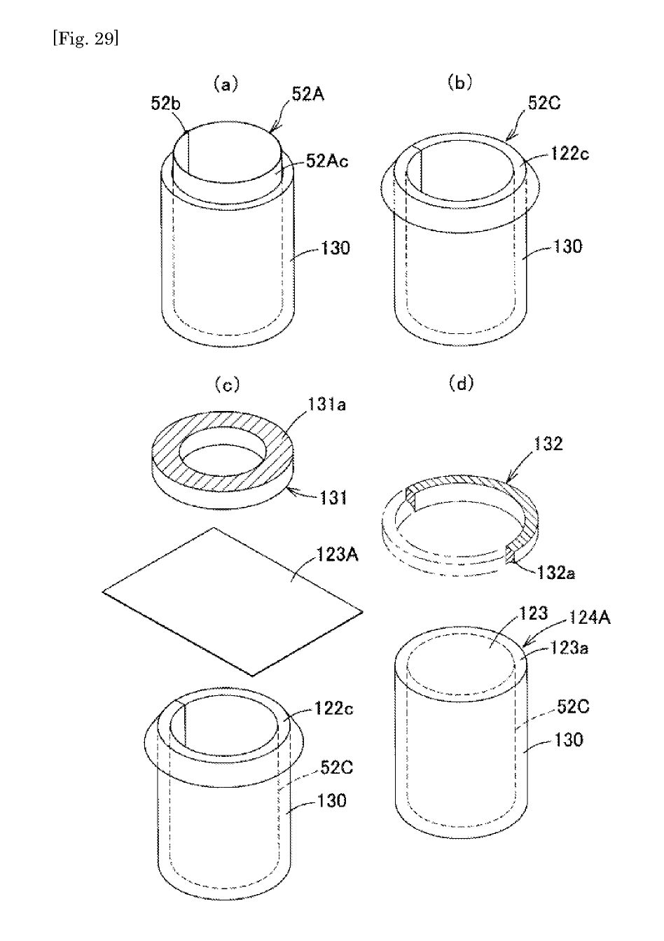

The lower end closing step is provided with a loading step, a fold-back step, a fusion bonding step, and a trimming step as shown in FIG. 29. The closed-end tubular member 124A is obtained by using a tubular attaching jig 130 which can be outward fitted to the body member 52A approximately with no gap, loading the body member 52A into the attaching jig 130 in the loading step while transferring the attaching jig 130, folding back the lower portion 52Ac of the body member 52A outside so as to form the body side lower end joint portion 122c in the fold-back step, fusion bonding the bottom portion film 123A to the body side lower end joint portion 122c in the fusion bonding step, and trimming an unnecessary portion of the lower portion 52Ac of the body member 52A and the bottom portion film 123A while leaving the lower end joint portion 124a in the trimming step. A description will be given below specifically.

First of all, the cylindrical body member 52A is loaded to the tubular attaching jig 130 in the loading step as shown in FIG. 29(a). A thickness of the attaching jig 130 is set to be approximately equal to or slightly larger than a width of the lower end joint portion 124a. Further, a height of the attaching jig 130 is set to a height at which the upper end portion of the body member 52A protrudes upward from the attaching jig 130 in a state in which the body member 52A is loaded into the attaching jig 130. As the attaching jig 130, it is possible to employ an attaching jig which is formed into a tubular shape having a transverse sectional shape which conforms to a transverse sectional shape of the body member 52A.

Next, in the fold-back step, the body member 52C forming the body side lower end joint portion 122c which is comprised of the fold-back portion and is formed into the endless annular shape is manufactured in the body member 52A in the upper side of the attaching jig 130, by folding back the lower portion 52Ac of the body member 52A protruding upward from the attaching jig 130 outside so as to be reversed inside and outside around an upper end edge of the attaching jig 130, as shown in FIG. 29(b). As mentioned above, it is possible to easily and efficiently form the endless annular body side lower end joint portion 122c by folding back the lower portion 52Ac of the body member 52A. It is preferable to structure the lower portion 52Ac such that the diameter thereof is expanded toward the lower side. According to the structure, the fold-back work of the lower portion 52Ac is easily carried out.

Next, in the fusion bonding step, the bottom portion film 123A is fusion bonded to the body side lower end joint portion 122c by feeding the bottom portion film 123A to the upper side of the body side lower end joint portion 122c of the body member 52C, employing a heating plate 131 having an annular heating portion 131a which is slightly wider than the upper surface of the attaching jig 130, and pinching the body side lower end joint portion 122c and the bottom portion film 123A between the heating portion 131a of the heating plate 131 and the attaching jig 130, as shown in FIG. 29(c). The bottom portion film 123A can be supplied to the upper side of the body side lower end joint portion 122c one by one, however, it is preferable to sequentially supply an elongated band-like bottom portion film 123A to the upper side of the body side lower end joint portion 122c. Further, in the case that the seal portion 54b comprised of the protruding portion is formed in the lower end joint portion 124a, an annular fitting groove or fitting protruding portion is formed in the upper surface of the attaching jig 130 and a fitting protruding portion or a fitting groove fitted in a concavo-convex manner to the fitting groove or the fitting protruding portion of the attaching jig 130 is formed in a heating surface of the heating plate 131 which is used in the fusion bonding step.

Next, in the trimming step, the tubular member 124A having the lower end joint portion 124a is obtained by pressing a blade portion 132a of a trimming blade 132 to an upper surface of the attaching jig 130, cutting the lower end portion of the bottom portion film 123A and the body member 52C protruding outward from the attaching jig 130, as shown in FIG. 29(d), the lower end joint portion 124a being obtained by fusion bonding the body side lower end joint portion 122c of the body member 51C and the outer peripheral joint portion 123a in the outer peripheral portion of the lower end closing member 123 to the lower end portion. It is possible to discharge the unnecessary portion of the body member 52C together with the unnecessary portion of the bottom portion film 123A to the outside of the line by structuring such that a part of the fusion bonded portion between the bottom portion film 123A and the body member 52C is left in the unnecessary portion side. Accordingly, this structure is preferable.

### <Reversing Step>

Next, in the reversing step, the container main body 124B is obtained, for example, by inserting a cylindrical reversing jig into an inner side of the tubular member 124A, pressing the center portions of the tubular member 124A and the lower end closing member 123 into the reversing jig, and reversing the tubular member 124A inside and outside, as shown in FIG. 30. A reversing work of the tubular member 124A can be smoothly carried out by employing a tubular member which is formed into a circular cone or a pyramid having a smaller transverse sectional shape in a lower end side than in an upper end side, as the tubular member 124A. Accordingly, this structure is preferable.

### <Spout Attaching Step>

Next, in the spout attaching step, the body side upper end joint portion 52a closing the upper end opening in the upper end portion of the body member 52C is formed by pinching the upper end portion of the body member 52C by the heating portions 113a in a state in which the main body portion 55a of the spout 55 is arranged inside the upper end portion of the body member 52C of the container main body 124B, and the pouch container 121 is obtained by pinching the main body portion 55a of the spout 55 to the center portion in the lateral direction of the body side upper end joint portion 52a of the body member 52C, fusion bonding the main body portion 55a of the spout 55 to the upper end portion of the body member 52C, and attaching the spout 55 to the body member 52C, in the same manner as the body member 52B shown in FIG. 26.

In the manufacturing method of the pouch container 121, since the body side lower end joint portion 122c comprised of the endless annular fold-back portion is formed in the body member 52A in the upper side of the attaching jig 130 by loading the body member 52A into the attaching jig 130, and folding back the tubular lower portion 52Ac of the body member 52A protruding upward from the attaching jig 110 so as to be reversed inside and outside around the upper end edge of the attaching jig 130, it is possible to efficiently form the body side lower end joint portion 122c in the lower end portion of the body member 52A. Further, since the fold-back work of the body member 52A can be comparatively easily automated, and the loading step, the fusion bonding step, and the trimming step can also be comparatively easily automated, it is possible to automate a whole of the lower end closing step. Further, since the width of the body side lower end joint portion 122c is the size in correspondence to the width of the upper end surface of the attaching jig 130, it is possible to sufficiently secure a width of the lower end joint portion 124a obtained by fusion bonding the body side lower end joint portion 122c of the body member 122 of the pouch container 121 and the outer peripheral portion of the lower end closing member 123 over a whole periphery, and it is possible to prevent the bonding strength and the liquid tightness from being lowered due to partial reduction of a fusion bonding area. Further, since the tubular member 124A is reversed inside and outside, the body side lateral part joint portion 122b and the lower end joint portion 124a are arranged inside the container main body 124 and do not protrude outward. As a result, it is possible to improve the design property of the pouch container 121.

Next, a description will be given of a sealing performance improved structure which improves a sealing performance between the body side end part joint portion and the closing member, that is, the sealing performance improved structure between the body side lower end joint portion 4a and the lower end closing member 5, and between the body side lower end joint portion 4Ca and the lower end closing member 5, in the pouch containers 1, 1A, and 1B, between the body side upper end joint portion 4f and the upper end closing member 21 in the pouch containers 1C and 1D, between the body side lower end joint portion 52c and the lower end closing members 53 and 53B in the pouch containers 51, 51A, and 51B, and between the body side upper end joint portion 52f and the upper end closing member 71 in the pouch containers 51C to 51E. In the embodiment described below, the body member including the body members 4 and 52 is collectively expressed by a body member 150, the joint portion of the body member including the body side lower end joint portions 4a, 4Ca, and 52c and the body side upper end joint portions 4f and 52f is collectively expressed by a body side end part joint portion 151, and the closing member including the lower end closing members 5, 53, and 53B and the upper end closing members 21 and 71 is collectively expressed by a closing member 152. Further, a body member having an oval transverse section is expressed by a body member 150A, an oval annular body side end part joint portion is expressed by an end part joint portion 151A, and an oval closing member is expressed by a closing member 152A.

As the sealing performance improved structure, it is possible to employ a structure which improves the sealing performance by controlling the overlapping number of the film materials due to the wrinkle generated in the body side end part joint portion 151 to be three or less, preferably two or less, a structure which improves the sealing performance by partly strongly fusion bonding the body side end part joint portion 151 and the closing member 152, and a structure obtained by the both.

The sealing performance improved structure which controls the overlapping number of the film materials due to the wrinkle is formed by previously applying a wrinkle collecting portion comprised of a through hole 161, a wrinkle collecting portion comprised of an incision 162, a wrinkle collecting portion comprised of a notch 163, an optional combination of these wrinkle collecting portion to the body side end part joint portion 151 before bending one end portion of the body member 150 inside. In the case of employing a body member forming a body side lateral part joint portion 153 obtained by rolling up the film material into a tubular shape and butt seaming or envelope bonding both end portions, as the body member 151, the body side lateral part joint portion 153 in the body side end part joint portion 151 comes to a state in which two film materials are superposed even in a no-wrinkle state, and the wrinkle is hard to be formed in comparison with the other portions. Further, in the case that the wrinkle is further formed in the body side lateral part joint portion 153, three or more of film materials are superposed and the sealing performance is lowered. As a result, it is preferable to structure such as to prevent the wrinkle from being generated in the body side lateral part joint portion 153 in the body side end part joint portion 151, for example, such as to form no wrinkle collecting portion.

(Wrinkle Collecting Portion Comprised of Through Hole)

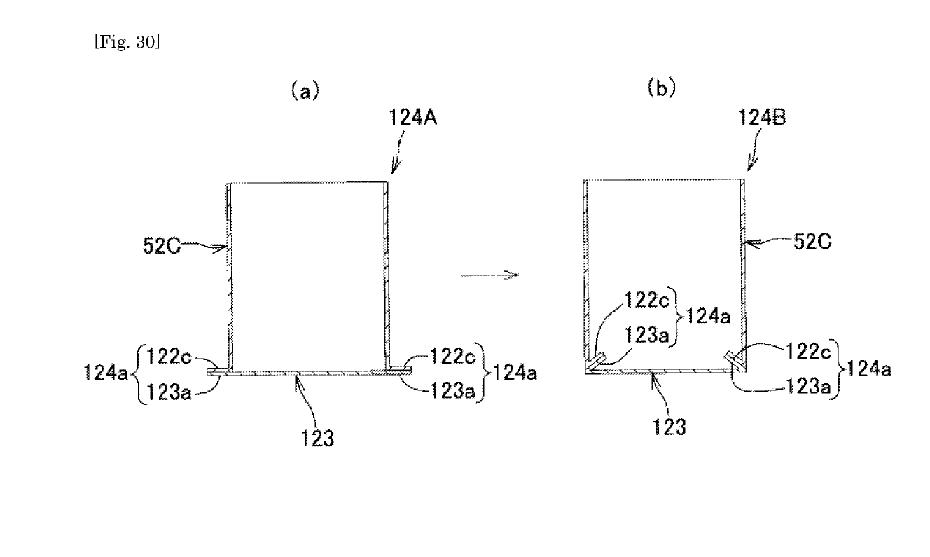

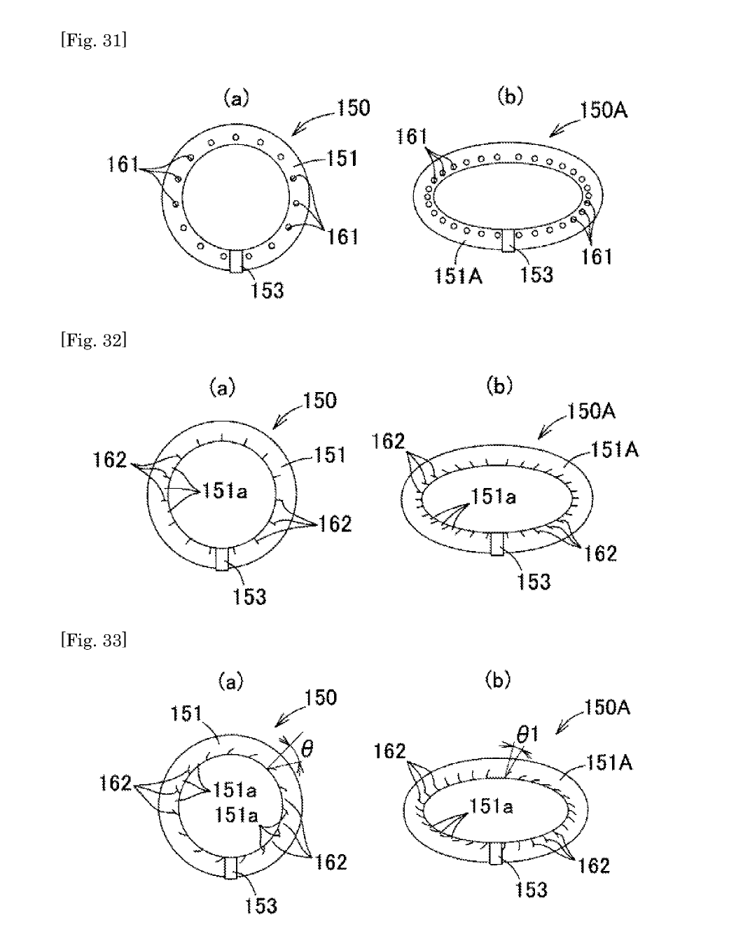

Specifically, as shown in FIG. 31(a), a plurality of wrinkle collecting portions comprised of through holes 161 are formed in a midstream portion in a width direction of the body side end part joint portion 151 so as to be spaced in a peripheral direction. In the case that the through holes 161 are formed as mentioned above, the through holes 161 are deformed when the body side end part joint portion 151 is formed by bending one end portion of the body member 150, whereby it is possible to reduce the number of the wrinkles generated in the body side end part joint portion 151, and it is possible to make the size of the wrinkle small. As a result, it is possible to improve the sealing performance between the body side end part joint portion 151 and the closing member 152.

As the through hole 161, it is possible to form a through hole having an optional shape such as a round hole, an oval hole, and a square hole. Further, if the size of the through hole 161 in relation to the width direction of the body side end part joint portion 151 is too large, a fusion bonding area to the closing member 152 is reduced and the sealing performance is lowered. If the size is too small, it is impossible to sufficiently control generation of the wrinkle. Accordingly, it is preferable to set the size between 10 and 50% of the width of the body side end part joint portion 151. Further, it is preferable to arrange the center position of the through hole 161 in relation to the width direction of the body side end part joint portion 151 closer to an inner peripheral side than the center position in the width direction of the body side end part joint portion 151 for effectively preventing the wrinkle in the inner peripheral side portion of the body side end part joint portion 151 where the wrinkle tends to be generated, and it is preferable to arrange it 5 to 50% outside a whole width of the body side end part joint portion 151 in the width direction from the inner peripheral edge of the body side end part joint portion 151. Further, according to the structure, since the through hole 161 is not formed in an outer peripheral side portion of the body side end part joint portion 151, it is possible to securely fusion bond the outer peripheral side portion of the body side end part joint portion 151 and the closing member 152 without pause by the through hole 161.

Further, the through holes 161 can be formed at regular intervals in the peripheral direction, and can be formed at different intervals. For example, as shown in FIG. 31(b), in the oval annular body side end part joint portion 151A, a radius of curvature of both end portions in a major axis direction in the body side end part joint portion 151A becomes smaller than a radius of curvature of a midstream portion in the major axis direction, and a lot of wrinkles are generated in both end portions of the major axis when the body side end part joint portion 151A is formed by bending one end portion of the body member 150A. As a result, in the body side end part joint portion having the portion with different radii of curvature like the oval annular body side end part joint portion 151A, it is preferable to structure such that the number of the wrinkles is reduced by setting an arrangement pitch of the through holes 161 formed in the portion having the smaller radius of curvature smaller than an arrangement pitch of the through holes 161 formed in the portion having the larger radius of curvature.

(Wrinkle Collecting Portion Comprised of Incision)

As shown in FIG. 32(a), a plurality of wrinkle collecting portions comprised of incisions 162 can be formed at regular intervals in a peripheral direction in an inner peripheral portion of the body side end part joint portion 151. According to the structure mentioned above, the inner peripheral portion of the body side end part joint portion 151 can be divided into a plurality of joint pieces 151a by the incisions 162, and the adjacent joint pieces 151a are superposed when the body side end part joint portion 151 is formed by bending one end portion of the body member 150. As a result, it is possible to prevent the wrinkle from being generated in the body side end part joint portion 151, and it is possible to improve the sealing performance between the body side end part joint portion 151 and the closing member 152. Further, it is possible to prevent the outer appearance from being lowered by the wrinkle even in the case that the body side end part joint portion 151 is exposed to the external portion.

Further, as shown in FIG. 31(b), in the oval annular body side end part joint portion 151A, it is preferable to structure such that the number of the wrinkles is reduced by setting an arrangement pitch of the incisions 162 formed in the portion having the smaller radius of curvature smaller than an arrangement pitch of the incisions 162 formed in the portion having the larger radius of curvature in the same manner as the wrinkle collecting portion comprised of the through holes 161.

If a length of the incision 162 is too short, it is not possible to sufficiently remove the wrinkles. If the length is too long, the sealing performance is lowered. As a result, it is preferable to set the length between 10 and 70% of the width of the body side end part joint portion 151A. Further, according to the structure mentioned above, since the incision 162 is not formed in an outer peripheral side portion of the body side end part joint portion 151, it is possible to securely fusion bond the outer peripheral side portion of the body side end part joint portion 151 and the closing member 152 without pause by the incision 162.

The incision 162 can be formed in a direction which is orthogonal to a tangential direction of an inner peripheral edge of the body side end part joint portion 151, however, is preferably formed at an angle θ1 in one direction in relation to the direction which is orthogonal to the tangential direction of the inner peripheral edge of the body side end part joint portion 151, as shown in FIGS. 33(a) and 33(b). According to the structure mentioned above, it is possible to prevent the wrinkle from being generated in the body side end part joint portion 151 by controlling so that the overlapping number of the adjacent joint pieces 151a is as small as possible, and it is possible to improve the sealing performance between the body side end part joint portion 151 and the closing member 152. Further, even in the case that the body side end part joint portion 151 is exposed to the external portion, it is possible to prevent the outer appearance of the pouch container from being lowered by the wrinkle, and it is possible to improve the design property of the pouch container by the regular incision 162 in one direction. Further, it is possible to structure such as to prevent the stress concentration from being generated in the base end portion of the incision 162 by forming small holes in a base end portion (an outer peripheral side end portion) of the incision 162. It is preferable to set the angle δ1 between 0 and 70 degrees since the overlapping number of the film is increased if the angle is too large.

(Wrinkle Collecting Portion Comprised of Notch)

As shown in FIG. 34(a), a plurality of wrinkle collecting portions comprised of V-shaped notches 163 can be formed at regular intervals in a peripheral direction in an inner peripheral portion of the body side end part joint portion 151. According to the structure mentioned above, since the inner peripheral portion of the body side end part joint portion 151 is divided into a plurality of joint pieces 151b by the notches 163, and the joint pieces 151b which are adjacent in a narrowing direction of the notches 163 come close when the body side end part joint portion 151 is formed by bending one end portion of the body member 150 inside, it is possible to prevent the wrinkle from being generated in the body side end part joint portion 151, and it is possible to improve the sealing performance between the body side end part joint portion 151 and the closing member 152. Further, it is possible to prevent the outer appearance of the pouch container from being lowered by the wrinkle even in the case that the body side end part joint portion 151 is exposed to the external portion. The adjacent notches 163 are continuously formed, however, may be formed so as to be spaced.

Further, as shown in FIG. 31(b), in the oval annular body side end part joint portion 151A, it is preferable to structure such that the number of the wrinkles is reduced by setting an arrangement pitch of the notches 163 which are formed in a portion having a smaller radius of curvature to be smaller than an arrangement pitch of the notches 163 which are formed in a portion having a larger radius of curvature, in the same manner as the wrinkle collecting portion comprised of the through hole 161. Further, it is possible to structure such that the number of the wrinkles is reduced by setting a notch width in an inner peripheral edge side of the body side end part joint portion 151A in the notch 163 formed in a portion having a smaller radius of curvature to be larger than a notch width of the notch 163 formed in a portion having a larger radius of curvature.

As the notch 163, it is possible to form a notch having a V-shaped form, a U-shaped form, a square shape, or an isosceles trapezoidal shape. If a depth of the notch 163 is too shallow, the wrinkle can not be sufficiently removed, and if the depth is too deep, the sealing performance is lowered. As a result, it is preferable to set the width between 10 and 70% of the width of the body side end part joint portion 151A. Further, according to the structure mentioned above, since the notch 163 is not formed in an outer peripheral side portion of the body side end part joint portion 151, it is possible to securely fusion bond the outer peripheral side portion of the body side end part joint portion 151 and the closing member 152 without pause by the notch 163. Further, it is possible to structure such that a stress concentration is prevented from being generated in a base end portion of the notch 163, by forming small holes in the base end portion (the outer peripheral side end portion) of the notch 163.

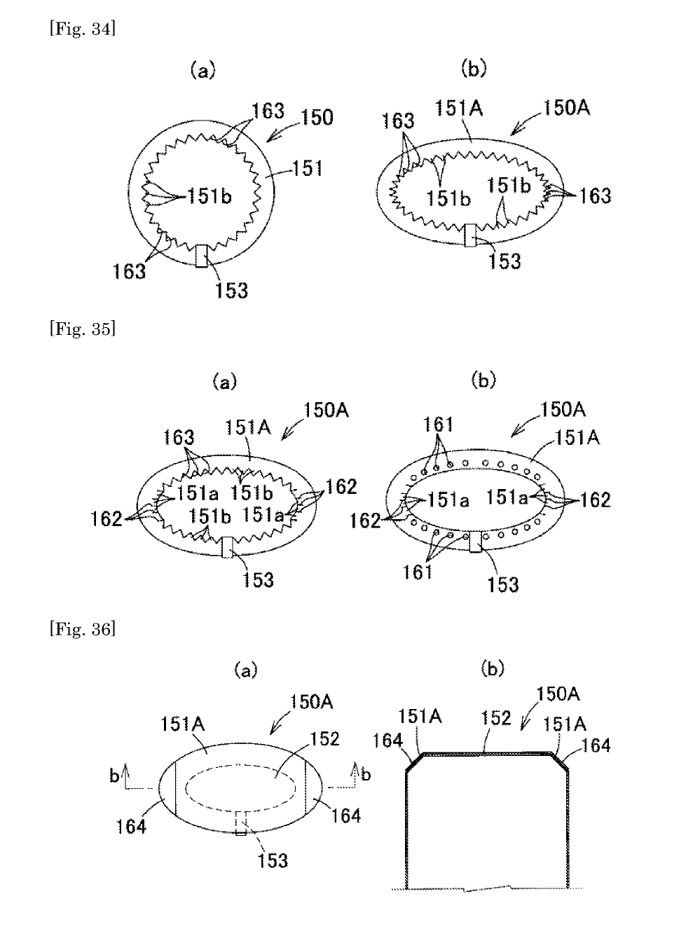

The through hole 161, the notch 163, and the incision 162 can be formed by being optionally combined, for example, the notch 163 and the incision 162 are formed in the body side end part joint portion 151 as shown in FIG. 35(a), or the incision 162 and the through hole 161 are formed as shown in FIG. 35(b). Particularly, since the incision 162 and the notch 163 are excellent in the wrinkle reducing action in comparison with the through hole 161 among the through hole 161, the incision 162, and the notch 163, it is preferable to form the incision 162 and the notch 163 in the portion having the smaller radius of curvature where the wrinkle tends to be generated.

Further, as shown in FIG. 36, in the case that the body member 150A having the oval transverse section and the oval closing member 152A are used, an inclined portion 164 which is inclined diagonally to the other end portion side of the body member 150A in an opposite side to the body side end part joint portion 151A is formed in both end side portions in a major axis of the oval in the oval annular fusion bonded portion between the body side end part joint portion 151A and the closing member 152A according to a preferable embodiment. In this case, the wrinkle generation is suppressed and the sealing performance is improved by carrying out the bending to the inner side of the body side end part joint portion 151A in both the end side portions of the major axis of the oval where the wrinkle tends to be generated step by step in both end portions of the inclined portion 164. The wrinkle collecting structure by the inclined portion 164 can be provided without being used together with the wrinkle collecting portion by the through hole 161, the incision 162, or the notch 163, however, is preferably provided together therewith.

The embodiment is structured such that the sealing performance is improved by reducing the wrinkle generated in the body side end part joint portion 151 or 151A or making it smaller, however, a sealing performance improved structure improving the sealing performance can also be provided by partly strongly fusion bonding the body side end part joint portion 151 or 151A and the closing members 152 or 152A. The sealing performance improved structure can be used together with the sealing performance improved structure which is provided with the wrinkle collecting portion and the wrinkle collecting structure. A description will be given below of the case that the outer peripheral portion of the discoid closing member 152 is fusion bonded to the annular body side end part joint portion 151, however, the same structure can be applied to the case that the outer peripheral portion of the oval closing member 152A is fusion bonded to the oval annular body side end part joint portion 151A.

Specifically, as shown in FIG. 37, a fusion bonding portion 165 in an inner peripheral side portion of the fusion bonded portion between the body side end part joint portion 151 and the outer peripheral portion of the closing member 152 is fusion bonded at a higher temperature and a higher pressure than a fusion bonding portion 166 of an outer peripheral side portion. In this case, both elements can be fusion bonded by using a heating plate comprised of a pair of inner and outer ring-like heating plates 168A and 168B as the heating plate, outward fitting the body member 150 to a mandrel 167 so as to bend one end portion of the body member 150 inside, pressing the inner peripheral side heating plate 168A to the mandrel 167 side at a higher temperature and a higher pressure than the outer peripheral side heating plate 168B in a state in which the body side end part joint portion 151 and the closing member 152 are arranged in an upper surface of the mandrel 167, and pinching the body side end part joint portion 151 and the outer peripheral portion of the closing member 152 between the heating plates 168A and 168B and the mandrel 167, for example, as shown in FIG. 37(b) when the body side end part joint portion 151 and the closing member 152 are thermally fusion bonded. The sealing performance is enhanced by fusion bonding the body side end part joint portion 151 and the closing member 152 at the high temperature and the high pressure, however, since the film material constructing them tends to be unavoidably deteriorated by the heat, it is possible to sufficiently secure the sealing performance while preventing a thermal deterioration of the film material at the fusion bonding time as much as possible, by fusion bonding the inner peripheral side portion of the body side end part joint portion 151 where the great wrinkle is formed to the closing member 152 at the higher temperature and the higher pressure than the outer peripheral side portion.

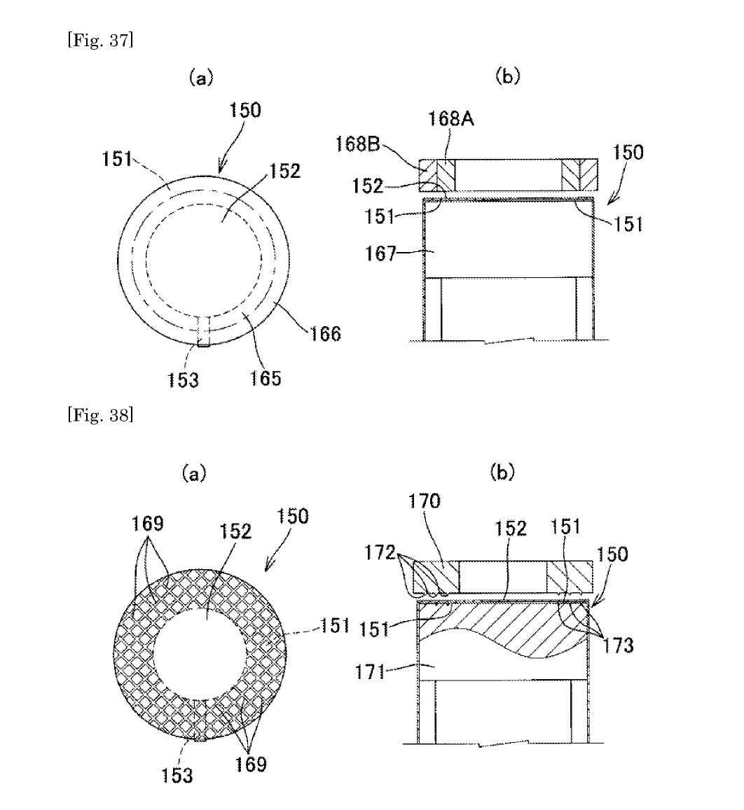

Further, as the other structure of the sealing performance improved structure which improves the sealing performance by partly strongly fusion bonding the body side end part joint portion 151 and the closing member 152, it is possible to form the annular seal portions 54b comprised of one protruding portion or a plurality of protruding portions in the midstream portion in the width direction of the fusion bonded portion between the body side end part joint portion 151 and the closing member 152 as shown in FIG. 19(a), or form grid-like seal portions 169 comprised of protruding portions in the fusion bonded portion between the body side end part joint portion 151 and the outer peripheral portion of the closing member 152 as shown in FIG. 37, according to preferable embodiments. In this case, as shown in FIG. 38(b), protruding portions 172 and groove portions 173 which are fitted in a concavo-convex manner in correspondence to the seal portion 54b and the seal portion 169 are formed in a lower surface of a heating plate 170 which thermally fusion bonds the body side end part joint portion 151 and the closing member 152, and an upper surface of a mandrel 171 facing thereto.

The description is given above of the embodiments according to the present invention, however, it goes without saying that the present invention is not limited to the embodiments mentioned above, but can be modified within a range which does not deviate from the scope of the present invention.

### REFERENCE SIGNS LIST

1 Pouch container
2 Container main body
3 Spout
3a Main body portion
3b Opening portion
3c Lid body
4 Body member
4a Body side lower end joint portion
4b Body side upper end joint portion
4c Body side lateral part joint portion
4d Main body portion
5 Lower end closing member
6 Inside member
6a Inside fusion bonding portion
7 Outside member
7a Outside fusion bonding portion
8 Lower end closing structure
8A Lower end closing structure
6A Inside member
8B Lower end closing structure
7B Outside member
8C Lower end closing structure
4Ca Body side lower end joint portion
4Cb Inward bent portion
4Cc Outward bent portion
1A Pouch container
4e Collar portion
10 Closing structure
11 Upper end closing member
11a Outer peripheral joint portion
11b Through hole
12 Spout
12a Opening portion
12b Flange portion
12c Lid member
1B Pouch container
4Ba Body side upper end joint portion
15 Pouring portion
1C Pouch container
4f Body side upper end joint portion
20 Upper end closing structure
21 Upper end closing member
21a Through hole
22 Inside member
23 Outside member
25 Collar portion
26 Lower end closing member
1D Pouch container
27 Bottom member
4A Body member
4Aa Body side lower end joint portion
4B Body member
30 Mandrel
31 Main body member
32 Head member
32a Corner portion for bending
33 Outer peripheral adsorption hole
34 Air blowout hole
35 Upper surface adsorption hole
36 Air suction path
37 Air supply path
38 Air suction path
40 Folding member
41 Taper surface
42 Fusion bonding head
43 Guide member
43a Guide surface
45 Fusion bonding plate
2A Container main body
4C Body member
46 Fusion bonding plate
46a Fusion bonding portion
51 Pouch container
52 Body member
52a Body side upper end joint portion
52b Body side lateral part joint portion
52c Body side lower end joint portion
52d Main body portion
52e Collar portion
52f Body side upper end joint portion
53 Lower end closing member
53a Outer peripheral joint portion
54 Container main body
54a Lower end joint portion
54b Seal portion
55 Spout
55a Main body portion
55b Opening portion
55c Lid body
55d Annular protruding portion
56 Lower end closing structure
56A Lower end closing structure
53B Lower end closing member
53Ba Outer peripheral joint portion
56B Lower end closing structure
51A Pouch container
60 Closing structure
61 Upper end closing member
61a Outer peripheral joint portion
61b Through hole
62 Spout
62a Opening portion
62b Flange portion
62c Lid member
51B Pouch container
52Ba Body side upper end joint portion
65 Pouring portion
51C Pouch container
70 Upper end closing structure
71 Upper end closing member
71a Outer peripheral joint portion
71b Through hole
75 Collar portion
76 Lower end closing member
51D Pouch container
77 Bottom member
52A Body member
52Ac Lower portion
52B Body member
53A Bottom portion film
54A Container main body
110 Attaching jig
111 Heating plate
111a Heating portion
112 Trimming blade
112a Blade portion
113 Heating plate
113a Heating portion
121 Pouch container
122 Body member
122b Body side lateral part joint portion
122e Body side lower end joint portion
123 Lower end closing member
123a Outer peripheral joint portion
124 Container main body
124a Lower end joint portion
52C Body member
123A Bottom portion film
124A Tubular member
124B Container main body
130 Attaching jig
131 Heating plate
131a Heating portion
132 Trimming blade
150 Body member
151 Body side end part joint portion
152 Closing member
153 Body side lateral part joint portion
151a Joint piece
151b Joint piece
150A Body member
151A Body side end part joint portion
152A Closing member
161 Through hole
162 Incision
163 Notch
164 Inclined portion
165 Fusion bonding portion
166 Fusion bonding portion
167 Mandrel
168A Heating plate
168B Heating plate
169 Seal portion
170 Heating plate
171 Mandrel
172 Protruding portion
173 Groove portion
L Boundary portion
W1 Width
W2 Width
θ Angle of incline
θ1 Angle

1. A self-standing pouch container comprising:
a body member which is made of a film material; and
a closing member which closes one end opening portion of the body member in a liquid tight manner and is made of a film material,
wherein an annular body side end part joint portion is formed in one end portion of the body member by being folded inside, and
wherein an outside member fusion bonded to an outer surface side of the container in the body side end part joint portion is provided as the closing member.

2. The pouch container according to claim 1, wherein the body member is comprised of a multilayer film formed by a lamination method or a coextrusion method with an adhesive agent.

3. The pouch container according to claim 1, wherein the outside member is comprised of a multilayer film manufactured by a lamination method or a coextrusion method with an adhesive agent.

4. The pouch container according to claim 1, wherein the closing member is provided with the outside member, and an inside member which is fusion bonded to an inner surface side of the container of the body side end part joint portion, the inside member is comprised of a single layer film or a multilayer film according to the coextrusion method, and the inside member comparts an inner peripheral edge of the body side end part joint portion so as not to be exposed to the container.

5. The pouch container according to claim 4, wherein a thickness of the film material of the inside member is set to be thinner than a thickness of the film material of the outside member, and one end opening portion of the body member is closed by the outside member.

6. The pouch container according to claim 4, wherein one of the outside member and the inside member is comprised of the film material which can close the one end opening portion of the body member, and the other of the outside member and the inside member is comprised of the annular film material which is fusion bonded to the body side end part joint portion, and the one of the outside member and the inside member.

7. The pouch container according to claim 4, wherein the body side end part joint portion is formed into an annular shape by folding back one end portion of the body member outside and thereafter folding inside a portion which is reversed inside and outside by the folding back, and a portion which is arranged inside the portion.

8. The pouch container according to claim 1, wherein the body member is provided with a body side lateral part joint portion obtained by rolling up the film material of the body member into a tubular shape and butt seaming both ends thereof.

9. The pouch container according to claim 1, wherein the body member is provided with a body side lateral part joint portion obtained by rolling up the film material of the body member and envelope bonding both ends.

10. The pouch container according to claim 1, wherein the film material of the body member is comprised of a film material of a multilayer structure having sealant layers which are provided in both surfaces, and one to a plurality of base material layers which are provided between both the sealant layers, and the film material of the closing member is comprised of a film material of a multilayer structure having a sealant layer which is provided in at least one outside surface, and a base material layer which is provided in a laminating manner in the sealant layer.

11. The pouch container according to claim 10, wherein a thickness of the sealant layer in the fusion bonded surface side between the body member and the closing member is set between 10 and 200 μm.

12. The pouch container according to claim 1, wherein a spout fusion bonding and retaining the main body portion is provided between the inner surfaces of the body member.

13. The pouch container according to claim 1, wherein a sealing performance improved structure is provided for improving the sealing performance between the body side end part joint portion and the closing member.

14. A self-standing pouch container comprising:
a body member which is made of a film material; and
a closing member which closes one end opening portion of the body member in a liquid tight manner and is made of a film material,
wherein an annular body side end part joint portion is formed in one end portion of the body member by being folded inside,
wherein the closing member is provided with an outside member which is fusion bonded to an outer surface side of the container in the body side end part joint portion, and/or an inside member which is fusion bonded to an inner surface side of the container in the body side end part joint portion, and
wherein a sealing performance improved structure is provided for improving a sealing performance between the body side end part joint portion and the closing member.

15. The pouch container according to claim 13, wherein a seal portion comprised of an annular protruding portion is formed in the fusion bonded portion between the body side end part joint portion and the closing member, as the sealing performance improved structure.

16. The pouch container according to claim 13, wherein a seal portion is formed like a grid in the fusion bonded portion between the body side end part joint portion and the closing member, as the sealing performance improved structure.

17. The pouch container according to claim 13, wherein a plurality of wrinkle collecting portions comprised of through holes are formed in a midstream portion in a width direction of the body side end part joint portion so as to be spaced in a peripheral direction, as the sealing performance improved structure.

18. The pouch container according to claim 17, wherein the center of the wrinkle collecting portion comprised of the through holes is arranged closer to the inner peripheral side than the center portion in the width direction of the body side end part joint portion.

19. The pouch container according to claim 13, wherein the sealing performance improved structure is obtained by forming a plurality of wrinkle collecting portions comprised of incisions extending from the midstream portion in the width direction of the body side end part joint portion to the inner peripheral edge so as to be spaced in the peripheral direction.

20. The pouch container according to claim 17, wherein the body side end part joint portion is formed into an annular shape by a combination of a plurality of circular arcs having different radii of curvature, and an arrangement pitch of the wrinkle collecting portions in a portion having a smaller radius of curvature is set to be smaller than an arrangement pitch of the wrinkle collecting portions in a portion having a larger radius of curvature.

21. The pouch container according to claim 13, wherein the sealing performance improved structure is comprised of a fusion bonding portion obtained by fusion bonding a fusion bonding portion in the inner peripheral side portion of the fusion bonded portion between the body side end part joint portion and the closing member at a higher temperature and a higher pressure than those of a fusion bonding portion in the outer peripheral side portion.

22. A manufacturing method of a pouch container comprising:
a body member forming step which forms a body member made of a film material; and
an end portion closing step which forms a body side end part joint portion by folding back one end portion of the body member inside, fusion bonds an outer peripheral portion of a closing member made of a film material to the body side end part joint portion, and attaches the closing member to one end portion of the body member so as to close one end opening of the body member in a liquid tight manner.

23. The pouch container according to claim 14, wherein a seal portion comprised of an annular protruding portion is formed in the fusion bonded portion between the body side end part joint portion and the closing member, as the sealing performance improved structure.

24. The pouch container according to claim 14, wherein a seal portion is formed like a grid in the fusion bonded portion between the body side end part joint portion and the closing member, as the sealing performance improved structure.

25. The pouch container according to claim 14, wherein a plurality of wrinkle collecting portions comprised of through holes are formed in a midstream portion in a width direction of the body side end part joint portion so as to be spaced in a peripheral direction, as the sealing performance improved structure.

26. The pouch container according to claim 25, wherein the center of the wrinkle collecting portion comprised of the through holes is arranged closer to the inner peripheral side than the center portion in the width direction of the body side end part joint portion.

27. The pouch container according to claim 14, wherein the sealing performance improved structure is obtained by forming a plurality of wrinkle collecting portions comprised of incisions extending from the midstream portion in the width direction of the body side end part joint portion to the inner peripheral edge so as to be spaced in the peripheral direction.

28. The pouch container according to claim 25, wherein the body side end part joint portion is formed into an annular shape by a combination of a plurality of circular arcs having different radii of curvature, and an arrangement pitch of the wrinkle collecting portions in a portion having a smaller radius of curvature is set to be smaller than an arrangement pitch of the wrinkle collecting portions in a portion having a larger radius of curvature.

29. The pouch container according to claim 14, wherein the sealing performance improved structure is comprised of a fusion bonding portion obtained by fusion bonding a fusion bonding portion in the inner peripheral side portion of the fusion bonded portion between the body side end part joint portion and the closing member at a higher temperature and a higher pressure than those of a fusion bonding portion in the outer peripheral side portion.
